(19) United States
(12) Patent Application Publication
(10) Pub. No.: US 2026/0050289 A1
(43) Pub. Date: Feb. 19, 2026

(54) VARIOUS SYSTEMS FOR VEHICLES, ENERGY GENERATION, ENERGY TRANSFER, ENERGY STORAGE, EARTHQUAKE MITIGATION, BUILDING CONSTRUCTION, COMPUTING, AND POLLUTION REDUCTION

(71) Applicant: Duplicent, LLC, Santa Monica, CA (US)

(72) Inventor: Curren Emmett Krasnoff, Santa Monica, CA (US)

(21) Appl. No.: 19/298,774

(22) Filed: Aug. 13, 2025

Related U.S. Application Data
(60) Provisional application No. 63/682,918, filed on Aug. 14, 2024.

(51) Int. Cl. G06F 1/16

(52) U.S. Cl. CPC G06F 1/1616; G06F 1/1652; G06F 1/1681

(57) ABSTRACT

A foldable computing device including a display portion including multiple folding sections. The display portion is configured to fold horizontally and vertically. The device includes a computing component positioned within a folding section and multiple hinge mechanisms, in which each connects two folding sections of the multiple folding sections. The display portion is foldable to a hand-held size in a fully folded configuration and a laptop size in an unfolded configuration, in which the hand-held size is smaller than the laptop size.

### CLAIM OF PRIORITY

This application claims priority under 35 USC § 119(e) to U.S. patent application Ser. No. 63/682,918, filed on Aug. 14, 2024, the entire contents of each of which are hereby incorporated by reference.

### BACKGROUND

Vehicle safety and efficiency have been ongoing concerns in the automotive industry. As vehicles become more complex and incorporate advanced technologies, there is a growing need for innovative systems to enhance performance, reduce emissions, and protect occupants during collisions.

Tire maintenance plays a crucial role in vehicle safety and fuel efficiency. Traditional tire designs often require complete replacement when tread wear occurs, leading to increased costs for vehicle owners and environmental waste. Additionally, maintaining proper tire pressure has been a challenge for many drivers, as it requires regular manual checks and adjustments.

Vehicle handling and maneuverability, particularly during turning maneuvers, have been areas of focus for automotive engineers. Conventional steering systems typically control only the front wheels, which can limit a vehicle's turning radius and responsiveness in certain driving scenarios.

Occupant protection during collisions remains a primary concern in vehicle design. While airbag technology has significantly improved safety outcomes, there is room for further innovation in deployment strategies and coverage areas to better protect vehicle occupants from various types of impacts.

Vehicle emissions, particularly carbon dioxide (CO2), continue to be a major environmental issue. Existing exhaust systems in both vehicles and industrial settings often release significant amounts of CO2 into the atmosphere, contributing to climate change concerns.

Structural stability of buildings during seismic events is an ongoing challenge in construction and civil engineering. Traditional building designs may be susceptible to swaying and deformation during earthquakes, potentially leading to structural damage or collapse.

In the field of energy generation and storage, there is a constant search for more efficient and sustainable methods. Conventional battery technologies face limitations in energy density and charging speeds, while many renewable energy sources struggle with intermittency and storage issues.

Wireless power transmission has been a long-standing goal in electrical engineering, with the potential to revolutionize how electronic devices are powered and charged. However, implementing widespread wireless electricity networks has faced technical challenges related to efficiency, range, and safety.

As computing devices become increasingly portable, there is a demand for more flexible and compact form factors that can adapt to various usage scenarios. Traditional laptops and tablets often have fixed configurations that limit their versatility in different environments.

These technological areas present opportunities for innovation to address existing limitations and improve performance, safety, and sustainability across various industries.

### SUMMARY

Additional techniques and example implementations are described in the corresponding Appendix.

According to an aspect of the present disclosure, a tire tread former is provided. The tire tread former includes a heating element and a tread forming element configured to compress the edges and width of a tire after heating. The machine may have replaceable forming elements for different treads. The machine may be configured to form treads for different size tires, accommodating different width and length tires. The machine may be automated and computer controlled. The heating element may be electric. The tread forming element may be compressed actuated by hydraulics, pneumatics, or other mechanical methods.

According to other aspects of the present disclosure, the tire tread former may include one or more of the following features. The machine may have different forming elements within the machine that are used depending on the tread selection. The forming elements may be manually replaced. The machine may take less than 30 minutes to reform each tire. The machine may be operated by a driver or a mechanic. The machine may have a display which the driver or mechanic may operate to make selections on the tread forming. The machine may analyze the tires for forming to determine size of the tire and where to form the treads.

According to another aspect of the present disclosure, a wheel turning system is provided. The wheel turning system includes a steering wheel configured to control front wheels and back wheels of a vehicle, where the front wheels turn in the direction of the steering wheel turn and the back wheels turn in the opposite direction of the steering wheel turn. The back wheels may turn with less of a degree than the front wheels. Different turn amounts of the steering wheel may have different turning degrees of the front wheels and back wheels.

According to other aspects of the present disclosure, the wheel turning system may include one or more of the following features. The turning of the back wheels may be selective to only turn for certain driving conditions. The back wheels may turn actuated by a certain acceleration measurement of the steering wheel. The system may also be for 4 wheel drive cars, where when the vehicle turns the wheels on the opposite side of the turning direction may spin more quickly than the wheels on the turning direction side. The wheel accelerator system may be actuated by an acceleration measurement of the steering wheel. The wheel accelerator system may be selective only for certain driving conditions. The wheel turning system and wheel accelerator system may work simultaneously to improve the turning capabilities of the vehicle. The systems may be computer controlled. For autonomous vehicles the systems may be actuated by sensor measurements instead of by the acceleration of the steering wheel.

According to another aspect of the present disclosure, a wheel with an air pump is provided. The wheel includes an electric air pump on the exterior rim of the wheel within the tire with an air conduit to the exterior of the wheel to pump air into the tire. A sensor measures the air pressure within the tire and sends tire air pressure data to a computer which controls the air pump for that tire, automatically filling the tire with air.

According to other aspects of the present disclosure, the wheel with an air pump may include one or more of the following features. The air conduit may be a valve that lets air in but not out. The valve may be located on the width of the rim of the wheel, or within the side walls of the tire.

According to another aspect of the present disclosure, head airbags for vehicles are provided. The head airbags are positioned in the interior roof of the vehicle or interior sides of the vehicle and configured to surround the head of the driver and passengers when the vehicle is in a collision.

According to other aspects of the present disclosure, the head airbags may include one or more of the following features. The head airbags may have 4 sides or be circular with a top airbag portion along the interior roof of the vehicle and an opening at the bottom for the person's head. Head airbags from the interior sides of the vehicle may deploy upwards over the driver's head then move downwards to surround the driver's head, or may deploy to curve around the driver's head reconnecting with the interior side of the vehicle, or may be in two parts that each curve around the driver's head. The head airbag may also be in the seat or head rest of the seats. The head airbags may be deployed when sensors on the vehicle detect a collision.

According to another aspect of the present disclosure, seat airbags for vehicles are provided. The seat airbags are within the seats of the vehicle and configured to surround the person's body when the vehicle is in a collision.

According to other aspects of the present disclosure, the seat airbags may include one or more of the following features. The seat airbags may be in two portions on near the edges of the seats and overlap in the center over the person's body when deployed. The seat airbags may be a single portion and surround the person's body starting from one side of the seat and going to the other side of the seat. The seat airbags may be deployed when sensors on the vehicle detect a collision.

According to another aspect of the present disclosure, vehicle protectors are provided. The vehicle protectors include a hood of the engine of the vehicle configured to move rapidly over the windshield of the vehicle when the vehicle is in a collision to prevent debris from entering the cabin of the vehicle through the windshield. Metal shielding stored in the doors of the vehicle is configured to raise rapidly to cover the windows of the vehicle when the vehicle is in a collision to prevent debris from entering the cabin of the vehicle through the windows. The top of the trunk of the vehicle is configured to move rapidly to cover the rear glass of the vehicle when the vehicle is in a collision to prevent debris from entering the cabin of the vehicle through the rear glass.

According to other aspects of the present disclosure, the vehicle protectors may include one or more of the following features. All the systems may work simultaneously to protect the driver and passengers of the vehicle. The systems may deploy the shielding elements when sensors on the vehicle detect a collision of the vehicle. The systems may be pneumatically actuated, hydraulically actuated, or actuated by another mechanical method. The systems may be computer controlled.

According to another aspect of the present disclosure, an automatic horn system for vehicles is provided. The automatic horn system includes a vision system or other system on the vehicle configured to identify approaching vehicles and honk the vehicle's horn automatically to alert the approaching drivers when the system detects an impending collision.

According to other aspects of the present disclosure, the automatic horn system may be computer controlled.

According to another aspect of the present disclosure, a vehicle CO2 mister and air filtration system is provided. The system includes a sprayer in the exhaust system of the vehicle configured to mist a very small amount of water or another biodegradable chemical into the exhaust fumes of the vehicle, collecting the CO2 gas in the mist. The mist with CO2 exits the exhaust system as droplets and the fumes exit without CO2 gas.

According to other aspects of the present disclosure, the vehicle CO2 mister and air filtration system may include one or more of the following features. The liquid may be recycled by the system with the exhaust system collecting the liquid after dispersion. The liquid may be filtered by a filtration system to remove CO2 particles from the liquid, then the filtered liquid may be reused for further CO2 collection. The filter may be a charcoal filter or other filter. The filter may be replaced after a time, or may be cleaned and reused. The tank for the fluid may have a conduit that is next to the fuel conduit, where the fuel port may also fill the mister liquid tank. There may be a selection button to select the filling location (fuel tank or mister tank) at the fuel port. The exhaust CO2 filter may be installed on existing vehicles as an aftermarket product or may be designed and manufactured for new vehicles. The exhaust CO2 filter may be installed over the exhaust, inserting filter systems into the exhaust and securing the filtration systems within the exhaust. Liquid conduits may attach to the inserted exhaust filtration system, through holes that are drilled into the exhaust pipe along the length of the exhaust pipe, where the liquid conduits may connect to the misters within the exhaust pipe at the holes and also connect to the liquid tank. There may be various numbers of misters within the exhaust system. The misters may be located on various sides of the exhaust pipe, and the fluid collection system may be opposite of the misters. The fluid collection system may be a vacuum and may be electric. The air from the exhaust may alternatively be vacuumed and filtered without fluid misters or with fluid misters, where the air may be vacuumed then sent through conduits through an air filtration system to remove the CO2, then the filtered air is released without CO2 or reduced CO2. The mister filter system and/or air filtration system may be located closer to the engine or within the engine and not in the exhaust system. The vacuum for the mist and/or air may be powered by the vehicle's battery. There may be a tank for the liquid, and electric pumps may pump the liquid to the mister. The pumps may be powered by the vehicle's battery. The mister may be electric and powered by the vehicle's battery. The exhaust system and liquid may be heated to best extract the CO2 gas. The heaters may be powered by the vehicle's battery. The exhaust system may have a sensor to measure the CO2 gas amount within the exhaust fumes and change the quantity of mist released depending on the measurement. The system may be computer controlled. There may be a conduit to the liquid tank and the tank may be refillable from the exterior of the vehicle. The liquid for the misters may be various types of liquid. The mist may ideally be a very fine mist. Various volumes of fluid may be sprayed by the misters.

According to another aspect of the present disclosure, a coal plant CO2 mister and air filtration system is provided. The system includes smoke stacks configured to funnel the coal smoke up then downwards and misters configured to spray water or another biodegradable chemical into the smoke within the downwards portion of the smoke stack so that the CO2 gas collects in the mist and exits the smoke stack as droplets with the air exiting without CO2 gas.

According to other aspects of the present disclosure, the coal plant CO2 mister and air filtration system may include one or more of the following features. The misters may alternatively be along the vertical length of the smoke stack, and the smoke stack may not be shaped downwards. The liquid may be collected by a vacuum after collecting the CO2 then reused, or filtered then reused, or reused then after time discarded. The system may additionally or alternatively have an air filtration system that vacuums the smoke and sends the smoke through an air filtration system to remove the CO2, then the filtered air is released. When along the vertical length of the smoke stack, the mist may be sprayed over a membrane that is permeable to air (e.g. smoke) but impermeable to liquid, so that the smoke may move through the membrane and the mist is sprayed onto the smoke over the membrane then is collected by the membrane and the fluid may be reused, filtered and reused, or discarded. The liquid sprayed into the smoke may be heated and the smoke stack may be heated at the area of the misters to best extract the CO2 gas. There may be a refillable tank for the liquid and an electric pump to pump the liquid to the misters. The misters may be electric. The system may be computer controlled. Various liquids may be used for the misters. The mist may ideally be very fine. The system may be installed on existing smoke stacks for coal plants, and/or installed for new coal plants.

According to another aspect of the present disclosure, a magnetic chassis for vehicles is provided. The magnetic chassis includes a magnetic interior core of the chassis, where the interior core of the chassis is an attractive magnet to the metal surrounding it, attracting on all sides or other configuration so that the chassis is more rigid and may deform less in a collision.

According to other aspects of the present disclosure, the magnetic chassis may include one or more of the following features. The magnet may be an electromagnet and the electromagnet may be off during normal driving, then when sensors on the vehicle detect a collision of the vehicle the electromagnet rapidly turns on to fortify the chassis. Other metal on the vehicle may have a similar system. The magnets may be in various patterns and geometries within the chassis and metal of the vehicle. There may also be repelling magnets surrounding the chassis elements and metal of the vehicle. The magnet may be a permanent magnet or an electromagnet. The electromagnet may be on during normal driving to improve driving performance from a more rigid chassis. The vehicle's battery may supply electricity to the electromagnet. The system may be computer controlled.

According to another aspect of the present disclosure, a magnetic earthquake stabilizer for buildings is provided. The magnetic earthquake stabilizer includes magnetic fortification for the metal frame of the building, where the core of the interior of the metal for the frame of the building is a permanent magnet or electromagnet, where the magnet is an attracting magnet on all sides to the surrounding metal or other configuration.

According to other aspects of the present disclosure, the magnetic earthquake stabilizer may include one or more of the following features. The magnets may be in various patterns and geometries within the metal frame. The electromagnet may turn on only when sensors detect an earthquake. The magnets may also be on the exterior of the frame of the building on all sides and have a repelling force to the metal frame and/or interior magnet, pushing the metal in the opposite direction of the swaying of the building during an earthquake in intervals, calibrated by sensors. The system may be computer controlled. The system may use both fortification magnets and pushing magnets.

According to another aspect of the present disclosure, a magnetic earthquake stabilizer foundation for buildings is provided. The magnetic earthquake stabilizer foundation includes very strong repelling electromagnets aligned in the foundation, where during an earthquake the building decouples from its foundation and the electromagnets turn on so that the building is suspended on the electromagnets such that the earthquake wave does not affect the building.

According to other aspects of the present disclosure, the magnetic earthquake stabilizer foundation may include one or more of the following features. The electromagnets may have alignment electromagnets around the repelling magnets that attract but with weaker magnetic force than the repelling magnets to keep the building aligned with its foundation. The building may have tethering wires to secure the building to the ground when the electromagnets are on. After the earthquake, the electromagnets turn off and the building recouples with its foundation. The device would be actuated by sensors and would be computer controlled.

According to another aspect of the present disclosure, earthquake expanders for buildings are provided. The earthquake expanders include expanders connecting metal within the foundation of a building which expand and move the metal frame of the building in intervals to counteract the swaying motion of the building in an earthquake.

According to other aspects of the present disclosure, the earthquake expanders may include one or more of the following features. There may be expanders on all sides of the building at the foundation and all the expanders may be aligned. The expanders may be calibrated by sensors and be computer controlled. The expanders may only work during an earthquake. The expanders may be pneumatically actuated, hydraulically actuated, or actuated by other mechanical methods.

According to another aspect of the present disclosure, magnetic wire is provided. The magnetic wire includes electricity transfer wire coated on the exterior with a magnetic lining along the length of the wire to keep the electricity in the wire and prevent loss of electricity from transfer.

According to other aspects of the present disclosure, the magnetic wire may include one or more of the following features. The magnetic lining may be a repelling magnet facing the direction of the wire and surround the wire. Alternatively, the magnet may be at the core of the wire along the length of the wire and be an attracting magnet. Alternatively, there may be an attracting magnet at the core of the wire and a repelling magnet around the wire along the length of the wire. The magnet may be a permanent magnet. Alternatively, the magnet(s) may be an electromagnet and may be powered by the electricity in the wire.

According to another aspect of the present disclosure, an electricity density battery is provided. The electricity density battery includes repelling magnets surrounding copper in a shape where electricity enters the copper and is compressed by the magnets increasing the energy density of the electricity and creating a battery, where the magnets remain around the copper to preserve the battery, and electricity is extracted from the battery through a copper wire which is surrounded by an inverse cone magnet aligned with the other magnets which surround the copper shape.

According to other aspects of the present disclosure, the electricity density battery may include one or more of the following features. Electricity also may enter the copper shape through the copper wire when filling the battery. There may be an attracting magnet at the core of the battery. The magnets may be permanent magnets or electromagnets. The copper may be in various configurations, patterns, and geometries. Other conductive materials may be used for the shape. When filling the battery with electricity the electromagnets may have a stronger magnetic force than when preserving the electricity in the battery. The inverse cone electromagnet may alter its magnetic force to change the quantity of electricity that exits the battery. The electromagnets may be computer controlled. The electricity in the battery may supply electricity to the electromagnets.

According to another aspect of the present disclosure, a pneumatic engine and air compressor is provided. The pneumatic engine and air compressor includes pneumatic pistons, where timed compressed air bursts move the pistons within cylinders, where the pistons may be in a similar configuration as conventional combustion engines, where the engine is connected to an electric air compressor which compresses air and sends the compressed air to the engine through conduits.

According to other aspects of the present disclosure, the pneumatic engine and air compressor may include one or more of the following features. Alternatively, each cylinder may have an air compressor. There may be a tank for the compressed air and the compressed air may go from the tank to the engine and the compressed air may go from the air compressor to the tank. Alternatively, each cylinder may have a tank. The force of the compressed air bursts may be varied by the engine and the timing of the compressed air bursts may be varied to change the power output of the engine and speed of the vehicle or other device. The engine, tank, and air compressor may be computer controlled. The engine may be used for vehicles. The system may be supplied with electricity from a battery.

According to another aspect of the present disclosure, a generator is provided. The generator includes an electromagnet surrounding copper, where the copper is stationary and the current of the electromagnet is sent across the electromagnet in a moving fluctuating arrangement altering the magnetic strength of the electromagnet in the moving fluctuating pattern, where because the current is moving in a pattern electrons are captured by the copper.

According to other aspects of the present disclosure, the generator may include one or more of the following features. There may be permanent magnets above and/or below the electromagnet, where the field of the electromagnet may alter the field of the permanent magnets allowing the copper to capture the electrons from the permanent magnets as well. Some of the electricity generated by the device may be used to supply electricity to the electromagnet. The device may be computer controlled. Instead of an electromagnet, there may be a permanent magnet that has two magnets one perpendicular to the other, and the second magnet is in a wave shape, where the first magnet is at the end of the second magnet, where the field of the second magnet interacts with the field of the first magnet, where such allows for electrons to be captured by the copper.

According to another aspect of the present disclosure, another generator is provided. The generator includes copper wire and magnetic wire arranged together in spiral configuration, where the spiral of magnetic wire and copper wire is arranged in a circle and surrounded by a repelling magnet circle to the magnet wire, where the surrounding repelling magnet circle decreases in magnetic strength around the circle such that the change of magnetic force moves the magnet wire around in a circle and allows electrons to be captured by the copper wire from the surrounding magnet as the spiral circle moves.

According to other aspects of the present disclosure, the generator may include one or more of the following features. There may be many copper wire and magnet wire spirals arranged together. The copper wire and magnet wire may not be in a spiral configuration but be aligned. Instead of a decreasing magnetic strength magnet, the spiral may have repelling wedge magnets on the spiral circle with a surrounding repelling magnet circle to the faces of the wedge magnets, where the change of magnetic force on the wedge magnets spins the spiral circle, where there may not be magnet wire for this version, alternatively, the surrounding circle magnet has repelling wedge magnets facing inwards and the spiral has repelling spiral magnet wire to the wedge magnets. The magnets may be permanent magnets. The wedge magnets and wire magnets may be electromagnets. Some of the electricity generated by the device may be supplied to the electromagnets.

According to another aspect of the present disclosure, heat setting construction systems are provided. The heat setting construction systems include molds for liquid metal that are externally heated to set the liquid metal in the molds, where once set the metal remains rigid. Alternatively, the liquid metal is not heated in the molds to set, but sets from reduced temperature. Alternatively, the molds heat solid metal or granular metal within the molds to melt the metal within the molds, then the heating stops and the liquid metal in the molds sets from reduced temperature. Once set the molds are removed.

According to other aspects of the present disclosure, the heat setting construction systems may include one or more of the following features. There may also be a heat setting wood fluid, where wood powder and/or pieces are mixed with a heat setting binder, where the wood fluid fills molds which are externally heated to set the wood fluid. Once set the molds are removed. Once set the wood remains rigid. Alternatively, the molds may provide the heat. The fluid could also be a mixture of wood, insulation, waterproofing materials, and a heat setting binder, where the fluid sets with heat in molds to form a structural, insulative, and waterproofing material. There may also be sections of molds and each fluid (metal, wood, waterproofing, insulation, etc) is individually poured into its respective section and heated. The layers may be individually set, then the next layer is set and bonded to the previous layer, alternatively, all the layers are set together and the molds may be in sections. The fluid may be set with a setting agent which is mixed into the fluid where the molds may mix the fluid. Alternatively, the molds may set the fluid with an ultrasonic method or ultraviolet method. The fluid(s) may be poured around pipes for plumbing, electrical wiring, and conduits for air conditioning and heating. Each may not degrade with heat.

According to another aspect of the present disclosure, angled gears are provided. The angled gears include gears configured at an angle each gear having semi circle gear teeth, where the angle of each gear may change while still turning the gears.

According to other aspects of the present disclosure, the angled gears may include one or more of the following features. Two gears with quarter circle gear teeth may fit at an angle with a gear with semi circle gear teeth, where the angle of each of the two gears with quarter circle gear teeth may change.

According to another aspect of the present disclosure, circular gear teeth are provided. The circular gear teeth include gears having circular gear teeth with cone shapes between the circles, where the cone base is connected to the circle and the point of each cone connects.

According to other aspects of the present disclosure, the circular gear teeth may include one or more of the following features. The cones may also curve inwards around the cone. Such may allow for two gears to have various connection angles close to 360 degrees. The gears may change their angle while turning.

According to another aspect of the present disclosure, foldable laptops and tablets are provided. The foldable laptops and tablets are foldable in 4 or more sections horizontally and vertically so that they can fit in a user's pocket. When unfolded they may be used.

According to other aspects of the present disclosure, the foldable laptops and tablets may include one or more of the following features. The computing components in each of the sections of the device may be connected through the fold. The top external fold of the laptop or tablet may be a smartphone or smartphone interface, where the user can use the smartphone without unfolding the device. The smartphone may use the computing components of the device that are used for the laptop or tablet. Each of the folds may have a hinge.

According to another aspect of the present disclosure, a wireless electricity network is provided. The wireless electricity network includes electronic devices configured to connect to a wireless electricity network similar to a Wi-Fi network, where the device detects an available network and the device connects to the wireless electricity network, where the device has a battery and the wireless electricity network charges the device's battery and/or powers the device.

to other aspects of the present disclosure, the wireless electricity network may include one or more of the following features. There may be local wireless electricity transmitters at different locations that each have a network. The networks of the wireless electricity transmitters may overlap at the edge of the network. Connecting to a wireless electricity transmitter may allow the device to automatically connect to other wireless electricity transmitters by that carrier when in the locations of the other wireless electricity transmitters. Various wireless electricity transmission systems may be used.

According to another aspect of the present disclosure, gas cylinders for generating electricity are provided. The gas cylinders include a tall airtight cylinder with helium or other lighter than air gas inserted at the bottom of the cylinder within the cylinder, where the gas may rise in the cylinder, and there may be a turbine fan(s) spaced apart on a rod within the cylinder, where the rod may connect the turbine fan(s) and the rod may be located through the center of the cylinder from top to bottom, where the turbine fan(s) may span the approximate width of the cylinder. As the gas rises, the turbine fan(s) may spin from the movement of the rising gas within the cylinder. The turbine fan(s) may spin the rod, and the rod may be connected to a generator to spin the generator from the spinning rod.

According to other aspects of the present disclosure, the gas cylinders may include one or more of the following features. There may be a gas collection device at the top of the cylinder, and hose(s) that run along the exterior of the cylinder from the top of the cylinder to the bottom of the cylinder, where the gas may be pumped by a pump(s) from the gas collection device at the top of the cylinder through the hose(s) and the gas may be reinserted within the cylinder at the bottom of the cylinder from the hose(s) in a continuous cycle. Alternatively, the gas may be released from the top of the cylinder and new gas may be pumped into the cylinder at the bottom. Some of the electricity produced by the generator may be used to power the pump(s), where the excess electricity may be used for various purposes, such as to supply electricity to the utility grid. The device may have a battery to power the pump(s) during a start-up period of the device, where some of the electricity produced by the generator may be used to charge the battery. The turbine fan blades may be angled and/or curved. There may be 2-5,000 turbine fan blades on each turbine fan. The cylinder may be 0.05-5,000 feet tall and the cylinder may be 0.05-5,000 feet wide. There may be 1-100,000 turbine fan(s) on the rod. The device may be controlled by a computer and software. The gas collection device may be powered by the battery during the start-up period of the device and the gas collection device may be powered by the generator after the start-up period of the device. The gas may be inserted through hose(s) with holes or valves in them along the bottom of the cylinder within the interior of cylinder, where the hose(s) may run across the bottom of the cylinder next to each other, or the hose(s) may be arranged into a circle or other shapes. There may be multiple rods (e.g. 2-1,000) spaced apart from each other within the interior of the cylinder arranged in a shape (e.g. circle, etc) or randomly arranged in relation to each other each with turbine fan(s) along the length of each rod where the turbine fan(s) may be spaced apart along the length of each rod equidistantly, where each rod may be connected to a generator, and each rod may spin from the spinning of the turbine fan(s) on each rod from the movement of the rising gas within the cylinder.

According to another aspect of the present disclosure, a metal particle movement magnet for generating electricity is provided. The metal particle movement magnet includes a magnet spaced above the ground, and below the magnet there is a metal particle releasing system which may be the same width and length as the magnet, where there may be holes spaced apart through the metal particle releasing system where the holes may open and close mechanically, where metal particles may be inserted through the holes of the metal particle releasing system and the metal particles may be attracted upwards to the magnet above, where there may be a turbine fan(s) or blades on a rod through the center of the magnet from the magnet to the ground, where the turbine fan(s) may spin from the rising movement of the metal particles and movement of the air from the rising metal particles through the turbine fan(s).

According to other aspects of the present disclosure, the metal particle movement magnet may include one or more of the following features. There may be a metal particle collection device which may remove the metal particles from the magnet continuously or in phases, where the metal particle collection device may remove the metal particles to one side of the magnet then drop the metal particles to the ground where the metal particles may be reinserted into the metal particle releasing system, where the process may repeat. The rod may be attached to a generator to spin the generator from the spinning of the turbine fan(s) on the rod. Some of the electricity produced by the generator may be used to power the metal particle collection system and the metal particle releasing system, where the excess electricity may be used for various purposes, such as to supply electricity to the utility grid. The device may have a battery to supply electricity to the metal particle collection device and metal particle releasing system during a start up period of the device, where some of the electricity produced by the generator may be used to supply electricity to the battery. The device may be controlled by a computer and software. The turbine fan(s) blades may be angled and/or curved. The turbine fan(s) may have 2-1,000 turbine fan blades on each turbine fan. There may be 1-100,000 turbine fan(s) spaced apart on the rod connected to the rod where the turbine fans may be spaced apart equidistantly. The magnet above may be an electromagnet and the electromagnet may be powered by the battery during the start up period of the device, and the electromagnet may be powered by the generator after the start up period of the device. The device may be 0.0001-5,000 feet tall and the device may be 0.0001-5,000 feet wide. There may be multiple rods (e.g. 2-3,000) extending to the ground from the magnet above where each rod may have turbine fan(s) and the rods may each be connected to a generator, where the rods may be arranged in a shape or randomly arranged in relation to each other. The metal particles may be magnet particles of the attracting polarity to the magnet above. The metal particles or magnet particles may be very small between 0.0001-20 mm. There may be many metal particles used for the device. When the metal particles are magnet particles there may be a magnet of the repelling polarity to the magnet particles on the ground facing upwards, with corresponding holes in the repelling magnet to the particle releasing system. The repelling magnet may be a permanent magnet or an electromagnet. When the repelling magnet is an electromagnet, the battery may supply electricity to it during the start up period of the device, and the generator may supply electricity to the repelling electromagnet after the start up period of the device. There may be a grid magnet(s), which may be a permanent magnet(s) or electromagnet(s) between the top magnet above and the ground, where the grid magnet(s) may be facing the ground attracting the metal particles or magnet particles. There may be multiple grid magnet levels (e.g. 2-5,000) between the top magnet above and the ground and the grid magnets may all be the same magnetic polarity facing the ground. The grid magnet(s) may have holes through the grid magnet(s) allowing the metal particles to pass through them. The grid magnet(s) may have a layer on the upwards facing side of the grid magnet to prevent the opposite polarity side of the magnet from attracting the metal particles or magnet particles to the upwards facing side. When the grid magnet(s) are electromagnets the battery may supply electricity to the grid electromagnet(s) during the start up period of the device, and the generator may supply electricity to the grid electromagnet(s) after the start up period of the device. The grid magnet(s) may be spaced apart between the top magnet above and the ground equidistantly from each other. There may be grid a magnet collection device(s) on each grid magnet which may move the metal particles or magnet particles off each grid magnet, pushing the metal particles or magnet particles to one side of each grid magnet portion, allowing the metal particles or magnet particles to pass through the holes of each grid magnet and be attracted to the next grid magnet above or to the top magnet above. The grid magnet collection device(s) may be powered by the battery during the start up period of the device, and the grid magnet collection device(s) may be powered by the generator after the start up period of the device. When the grid magnet is an electromagnet, the grid electromagnet(s) may turn off after attracting the metal particles or magnet particles to allow the metal particles or magnet particles to pass through the holes of the grid electromagnet(s), allowing the metal particles or magnet particles to be attracted to the next grid electromagnet above or top magnet above, where the grid electromagnets may shut off in series from bottom to top, and after the metal particles or magnet particles pass through each grid electromagnet each grid electromagnet may turn on again. When the grid magnet(s) is an electromagnet(s), the grid magnet collection device(s) may not be needed.

This summary provides an overview of the diverse range of concepts described in the disclosure, spanning automotive, construction, energy, computing, earthquake mitigation, and pollution reduction. The various aspects work to address challenges in safety, efficiency, sustainability, and technological advancement across multiple industries.

### BRIEF DESCRIPTION OF THE DRAWINGS

FIG. 1 illustrates a tire tread former system.

FIG. 2 depicts a wheel turning system and wheel accelerator for a vehicle.

FIG. 3 illustrates a system diagram of a wheel with an air.

FIG. 4 depicts a side orthogonal view of a head airbag system in a vehicle.

FIG. 5 depicts a side view of a seat airbag system for a vehicle.

FIG. 6 illustrates an orthogonal view of a vehicle protection system.

FIG. 7 illustrates a block diagram of an automatic horn system for a vehicle.

FIG. 8 depicts a vehicle CO2 mister system.

FIG. 9 illustrates a CO2 misting system for a coal plant.

FIG. 10 illustrates a magnetic chassis system for a vehicle.

FIG. 11 depicts a magnetic earthquake stabilizer system for a building.

FIG. 12 depicts a block diagram of a magnetic earthquake stabilizer foundation system.

FIG. 13 depicts a system diagram of an earthquake stabilization system for a building.

FIG. 14 depicts a cross-sectional view of a magnetic wire configuration for electricity transfer.

FIG. 15 illustrates a perspective view of an electricity density battery device.

FIG. 16 illustrates a pneumatic engine and air compressor system.

FIG. 17 illustrates a generator circuit with a copper wire and permanent magnet.

FIG. 18 depicts a generator system with electromagnets and copper components.

FIG. 19 depicts a heat setting construction system.

FIG. 20 illustrates a perspective view of an angled gear system.

FIG. 21 depicts an orthogonal view of a gear system with circular gear teeth.

FIG. 22 depicts a schematic view of a foldable laptop or tablet device.

FIG. 23 illustrates a wireless electricity network for powering electronic devices.

FIG. 24 depicts a perspective view of a gas cylinder device with a turbine fan system.

FIG. 25 depicts a metal particle movement magnet system.

Like reference numbers and designations in the various drawings indicate like elements.

### DETAILED DESCRIPTION

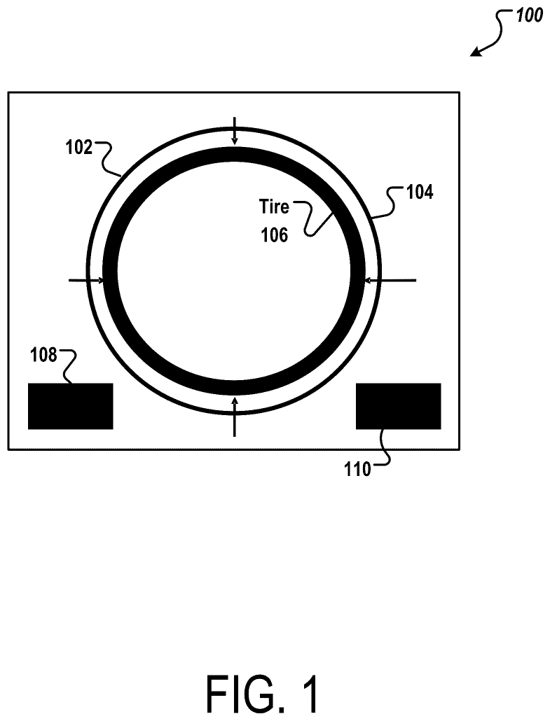

Referring to FIG. 1, a tire tread former system 100 may be used to reform treads on worn tires. The system 100 includes a heating element 102 and a tread forming element 104. In some cases, the heating element 102 melts the edge and width of rubber portions of a tire 106. The tread forming element 104 may then compress, by a compressor 110, the melted rubber to form new treads in the tire 106. The compressor 110 applies pressure directed radially inward from the outside edges of the tire 106 to press the melted rubber into the worn treads of the tire 106.

The system may accommodate different tread patterns. In some cases, the tread forming element 104 is replaceable to allow for forming various tread designs. Alternatively, the system contains multiple tread forming elements that can be selected based on the desired tread pattern. Based on the tread pattern of the tire 106, the system 100 can determine an appropriate tread forming element 104 to match the tread pattern.

A computer 108 may control the operation of the tire tread former system 100. The computer 108 may analyze the tire 106 to determine its size and where to form the new treads. In some cases, the system 100 includes a display that allows an operator to make selections regarding the tread forming process. In some implementations, the display is projected onto a screen communicatively coupled to the computer 108.

The tire tread former system 100 may include a tire extension attachment (not illustrated in FIG. 1, but can be aligned with the circumference of the tire 106), to attach additional tire material with treads to the tire 106. In some cases, the tire extension (e.g., extra material to be added to the outer surface of the tire 106) is substantially rigid and may not have a support structure in its interior. The tire extension may be circular and match the shape of the tire. The tire extension may be attached to the tire 106 by melting the outer face of the tire 106 and inner face of the tire extension and compressing both together to bond via the compressor 110, or just the outer face of the tire 106 or inner face of the tire extension may be melted and compressed with the outer face of the tire 106 to bond. Alternatively, an adhesive (e.g., glue) may be applied to the outer face of the tire 106 and/or the inner face of the tire extension, where both may be compressed together to bond the adhesive.

Multiple layers of tire extensions may be included that extend outward from the outer surface of the tire 106. Each tire extension layer may be approximately the width of the tire 106 (e.g., along a direction parallel to the axis of rotation, at a distance from the axis approximately equal to the radius of the tire 106). The multiple tire extensions may be attached to the worn tire in series, one after the other. In some cases, each tire extension has an independent support structure. Alternatively, the tire extensions share a common support structure, or the tire extension may not have a support structure.

The tire extension may be made of rubber. In some cases, the tire extension has a metal or other rigid lining material along its back face to help preserve the shape of the tire 106. The outer face of the tire extension may include treads to provide traction with the road surface.

The tire tread former system 100 may allow for reforming or adding treads on the tire 106 rather than replacing the tire 106 on a vehicle with a new tire. This capability may provide cost savings for drivers by extending the usable life of tires.

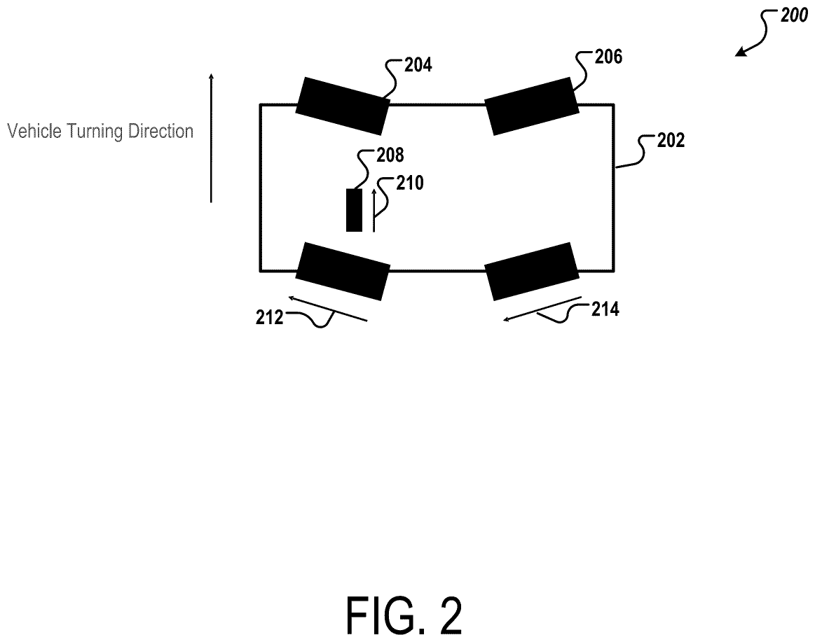

FIG. 2 illustrates circumstances in which a wheel turning system 200 is implemented in a vehicle 202 to enhance turning capabilities and improve maneuverability of the vehicle 202. The wheel turning system 200 includes a wheel accelerator. The system 200 may control front wheels 204 and back wheels 206 of the vehicle 202 in response to an input from a steering wheel 208.

In some cases, when the steering wheel 208 is turned, e.g., in a direction 210, the front wheels 204 turn in a direction 212 with a vector component aligned with the direction 210. Simultaneously, the back wheels 206 turn in a direction 214 with a vector component aligned opposite to the direction 210. This opposing wheel movement may allow for tighter turning radii and improved cornering ability.

The degree of turn for the back wheels 206 (e.g., an angle associated with the direction 214) may be less than that of the front wheels 204 (e.g., an angle associated with the direction 212). In other words, an absolute value of an angle between the vector along direction 212 and a normal vector along direction 210 may be less than an absolute value of an angle between the vector along direction 214 and the normal vector along direction 210. In some implementations, different turn amounts of the steering wheel 208 correspond to different turning degrees for both the front wheels 204 and back wheels 206. This variable turning response may provide more precise control across different driving scenarios.

The turning of the back wheels 206 may be selectively activated based on certain driving conditions. For example, the system 200 may engage back wheels 206 turning only at lower speeds or during parking maneuvers. In some cases, the back wheels 206 turning is actuated by detecting a certain acceleration measurement (e.g., by an output of an accelerometer integrated into a computer on the vehicle 202) or amount of turn of the steering wheel 208. This selective activation may optimize performance of the system 200 for specific situations while maintaining conventional handling in others.

For vehicles with four-wheel drive capabilities, the wheel accelerator aspect of the system 200 may be implemented. When the vehicle 202 turns, the wheels on the opposite side of the turning direction may spin more quickly than the wheels on the turning direction side. This differential wheel speed may further enhance turning ability of the vehicle 202.

The wheel accelerator function may also be selectively activated based on driving conditions or steering wheel 208 acceleration or turn measurements. In some implementations, both the wheel turning system 200 and wheel accelerator may operate simultaneously to provide comprehensive turning enhancement.

The system 200 may be computer-controlled, e.g., by a computer installed on the vehicle 202, allowing for precise coordination of wheel movements and speeds. For autonomous vehicles, the system 200 may be actuated by sensor measurements instead of steering wheel 208 input, enabling the vehicle 202 to optimize its turning performance based on environmental data.

In some cases, the wheel turning system 200 and wheel accelerator may be utilized for vehicle accident avoidance. The enhanced maneuverability provided by the system 200 may allow the vehicle 202 to execute more agile evasive maneuvers when detecting potential collision scenarios.

The combination of front wheels 204 and back wheels 206 turning control, along with differential wheel acceleration (e.g., providing acceleration inputs to one of the two front wheels 204 and/or one of the two back wheels 206), may provide the vehicle 202 with improved handling characteristics across a range of driving conditions. This system 200 may enhance overall vehicle safety and performance by offering more responsive and precise turning capabilities.

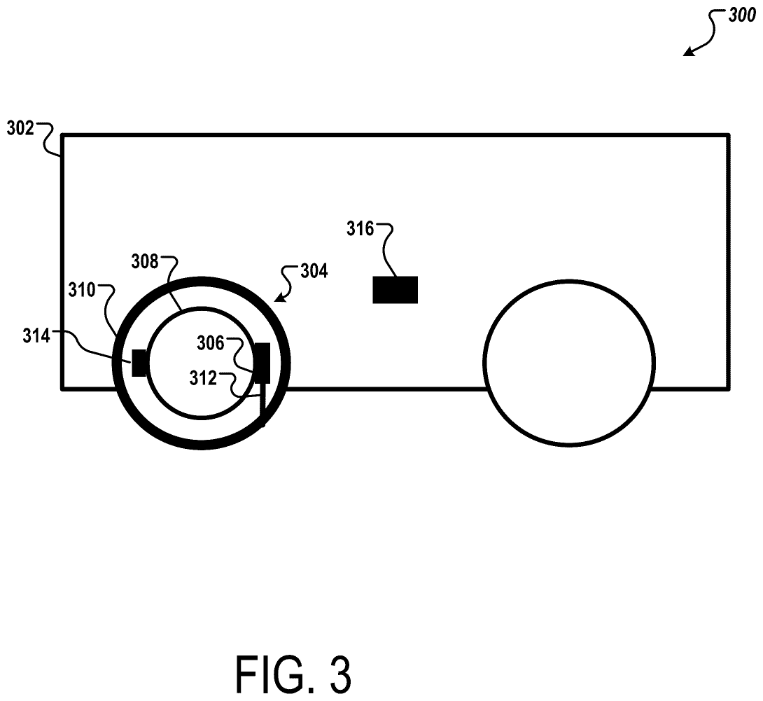

Referring to FIG. 3, a system 300 that includes a vehicle 302 with one or more wheels, e.g., wheel 304, with integrated air pumps, e.g., integrated air pump 306, in the wheels to automatically maintain proper tire pressure. As an example, the present description relates to the wheel 304. However, the vehicle 302 can include more than one wheel, in which one or more of the wheels includes an integrated air pump with associated functionality.

The wheel 304 on the vehicle 302 includes an electric air pump 306 mounted on an exterior rim 308 of the wheel 304 within a tire 310. The electric air pump 306 can also be mounted in other locations. The air pump 306 is connected to an air conduit 312 that extends to the exterior of the wheel 304, allowing air to be pumped into the tire 310. In some implementations, the air conduit 312 is a tube, channel, or any close passage that is operable to direct air from the air pump 306 to the tire 310.

A sensor 314 is positioned within the tire 310 to measure the air pressure. The sensor 314 may send tire air pressure data to a computer 316 which controls the air pump 306 for the tire 310. In some implementations, the computer 316 is communicatively coupled via a wired or wireless communication channel with one or more air pumps for one or more wheels of the vehicle 302 (e.g., the air pump 306 of the wheel 304). Similarly, in some implementations, the computer 316 is communicative coupled via a wired or wireless communication channel with one or more sensors for one or more wheels of the vehicle 302 (e.g., the sensor 314 of the wheel 304). Based on pressure readings received from the sensor 314 at the computer 316, the computer 316 may activate the air pump 306 to automatically fill the tire 310 with air when needed. For example, if the computer 316 determines that the pressure reading received from the sensor 314 is below a particular threshold, the compute 316 can transmit a signal to the air pump 306, initiating air to be pumped into the tire 310 until the threshold is met.

The air conduit 312 may include a valve that allows air to flow into the tire 310 but prevents air from flowing out. In some implementations, the valve is located on the width of the rim 308 of the wheel 304. Alternatively, the valve is positioned within the side walls of the tire 310.

This automated tire inflation system helps maintain optimal tire pressure without requiring manual intervention from the driver. By keeping tires properly inflated at all times, the system may contribute to safer driving conditions. Proper tire inflation can improve vehicle handling, increase fuel efficiency, and extend the life of the tires.

The integration of the air pump 306 within the wheel 304 itself allows for a compact design that does not interfere with the normal operation of the wheel 304 and tire 310. The electric air pump 306 may be powered by an electrical system of the vehicle 302.

In some cases, the computer 316 controlling the air pump 306 is connected to an onboard diagnostics system of the vehicle 302. In some implementations, the on board diagnostics system displays tire pressure information on a display to be viewed by the driver of the vehicle 302 and may enable alerts if any tire (e.g., the tire 310) requires attention (e.g., requires more air in order to operate effectively).

The automated nature of this system 300 may reduce the need for drivers to manually check and adjust tire pressure. This may be particularly beneficial for drivers who may not regularly monitor their tire pressure or for vehicles that frequently encounter varying road and temperature conditions that can affect tire pressure.

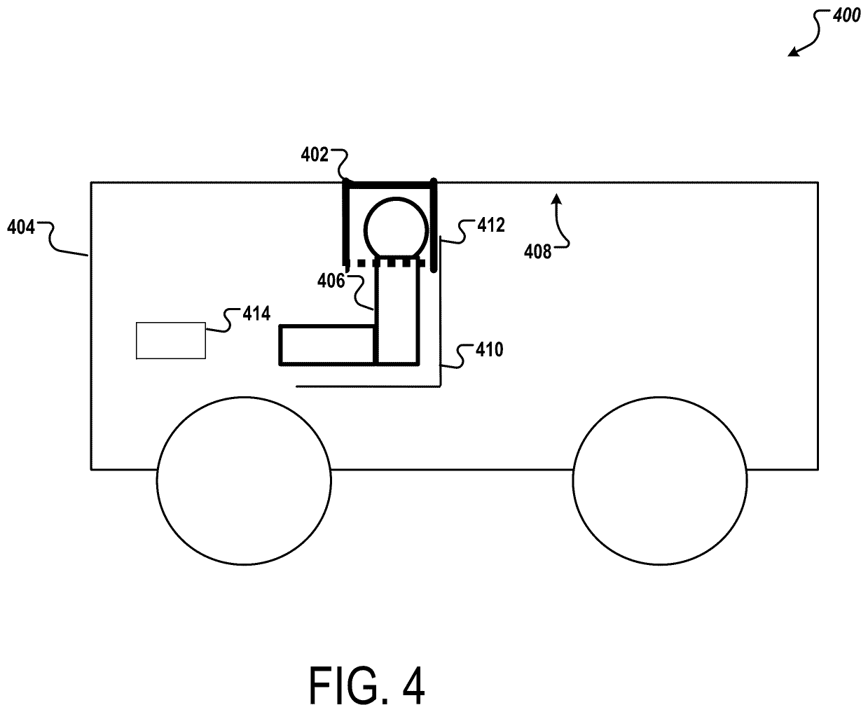

Referring to FIG. 4, a system 400 includes a head airbag 402 implemented in a vehicle 404 to provide enhanced protection for an occupant 406 during a collision. In some implementations, an airbag is available to more than one occupant of the vehicle 404. For ease of description, the system 400 includes the head airbag 402 for the occupant 406, but similar airbags can be implemented for other occupants of the vehicle 404 as well. The head airbag 402 surrounds and protects the head of the occupant 406 when deployed. In some implementations, the head airbag 402 includes multiple airbags that are implemented independently or implemented as a connected airbag unit.

In some cases, as illustrated, the head airbag 402 is positioned in an interior roof 408 of the vehicle 404. Alternatively, the head airbag 402 is located in an interior side of the vehicle 404. The positioning of the head airbag 402 may allow for rapid deployment to create a protective barrier around the head of the occupant 406 during impact events.

The head airbag 402 may have various configurations to effectively protect the occupant 406. In some implementations, the head airbag 402 has four sides to create a protective enclosure around the head. Alternatively, the head airbag 402 is circular in shape with a top airbag portion along the interior roof 408 of the vehicle 404 and an opening at the bottom for the head of the occupant 406.

If the head airbag 402 is positioned on the interior sides of the vehicle 404, different deployment mechanisms may be utilized. In some cases, the head airbag 402 deploys upwards over the head of the occupant 406 and then move downwards to surround the head. Another configuration involves the head airbag 402 deploying to curve around the head of the occupant 406 and reconnecting with the interior side of the vehicle 404. Some implementations may use a two-part design where each part curves around the head of the occupant 406 from opposite sides.

In addition to or instead of roof and side-mounted configurations, the head airbag 402 may be integrated into a seats 410 or a headrest 412 of the vehicle 404. This positioning may allow for more localized protection and faster deployment times.

The head airbag system 400 may utilize similar technology and materials as current vehicle airbags. This may include rapid inflation mechanisms and durable, flexible fabrics designed to withstand the forces involved in airbag deployment and impact absorption.

Deployment of the head airbag 402 may be triggered by sensors 414 on the vehicle 404 that detect a collision. The sensors 414 may be part of the vehicle's broader safety system, allowing for coordinated deployment of multiple safety features during an accident (e.g., automatic braking, automating steering, etc.).

By providing a protective barrier around the head of the occupant 406, the head airbag 402 helps reduce a risk of head injury during a collision. The surrounding design (e.g., the head airbag 402 surrounds, in various configurations, the head of the occupant 406) of the airbag 402 may offer protection from multiple angles, mitigating the effects of side impacts, rollovers, and other complex collision scenarios.

The integration of the head airbag 402 into vehicle safety systems of the vehicle 404 may complement existing airbag configurations, such as front and side airbags, to provide more comprehensive occupant protection. This multi-layered approach to vehicle safety may contribute to improved outcomes in various types of collision events.

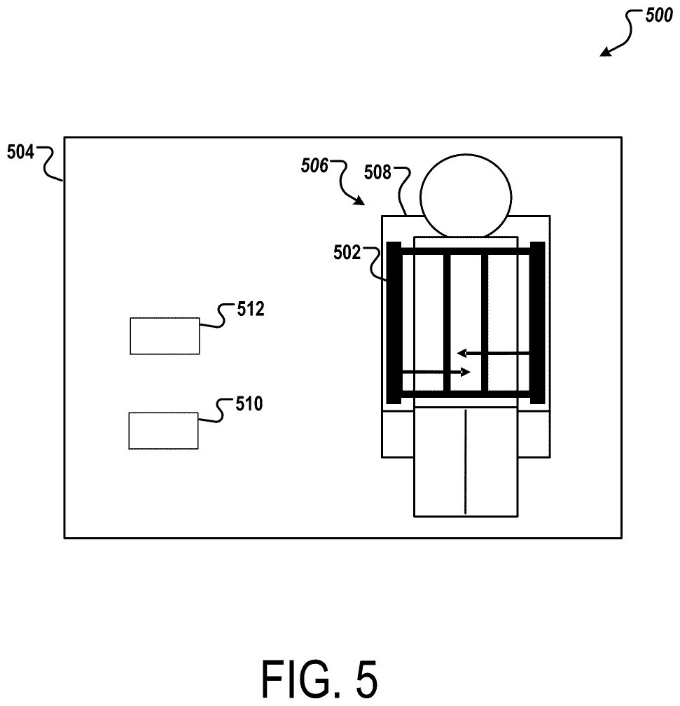

Referring to FIG. 5, a vehicle system 500 includes a seat airbag 502 implemented in a vehicle 504 to provide additional protection for an occupant 506 during collisions. The airbag 502 are integrated within a seat 508 of the vehicle 504 and designed to surround the occupant's body when deployed.

In some cases, the seat airbag 502 is configured as two separate portions positioned near edges of the seat 508. When activated (e.g., the airbag 502 is deployed, as during a collision), the two separate portions may overlap in a center over the occupant's body or torso, creating a protective enclosure. Alternatively, the seat airbag 502 is designed as a single portion that surrounds the occupant's body or torso, extending from one side of the seat 508 to the other.

The seat airbag 502 may utilize similar materials and inflation technology as current vehicle airbags. This may include rapid deployment mechanisms and durable, flexible fabrics capable of withstanding the forces involved in airbag activation and impact absorption.

Deployment of the seat airbag 502 may be triggered by sensors 510 on the vehicle 504 that detect a collision. The sensors 510 may be part of a broader safety system of the vehicle 504, allowing for coordinated activation of multiple safety features during an accident (e.g., automated braking and/or steering).

In some implementations, the seat airbag 502 operates in conjunction with other airbag systems in the vehicle 504, such as front, side, or head airbags. This multi-layered approach to occupant protection may provide more comprehensive coverage during various types of collision scenarios.

The integration of the airbag 502 within the seat structure may allow for faster deployment times compared to some externally mounted airbag systems. Additionally, the close proximity to the occupant 506 helps ensure more consistent positioning of the airbag 502 relative to the body of the occupant 506 during deployment.

The airbag 502 may be designed to accommodate different seat configurations and adjustments. In some cases, the vehicle system 500 may adapt a deployment of the airbag 502 based on the position of the seat 508 or the size of the occupant 506. For example, based on parameters of the seat 508 and/or the occupant 506, the system 500 can deploy the airbag 502 in one or multiple different configurations, as described in the present disclosure.

The seat airbag 502 may contribute to improved occupant safety by providing an additional layer of protection during collisions. By surrounding the occupant's body, the airbag 502 helps distribute impact forces and reduce the risk of injuries to the torso, arms, and legs.

In some implementations, the seat airbag 502 is designed with multiple chambers or sections that inflate to different pressures or at different rates, as determined by a computer 512 on the vehicle 504 that processes data related to the sensors 510, the seat 508, and the occupant 506, among other parameters. This variable inflation may allow the airbag 502 to provide optimized protection for different parts of the occupant's body.

The integration of airbag 502 within the seat 508 may also allow for more discreet safety features that do not significantly alter the appearance or comfort of the vehicle 504 interior. This may be particularly beneficial for vehicle designs where maintaining aesthetics or interior space is a priority.

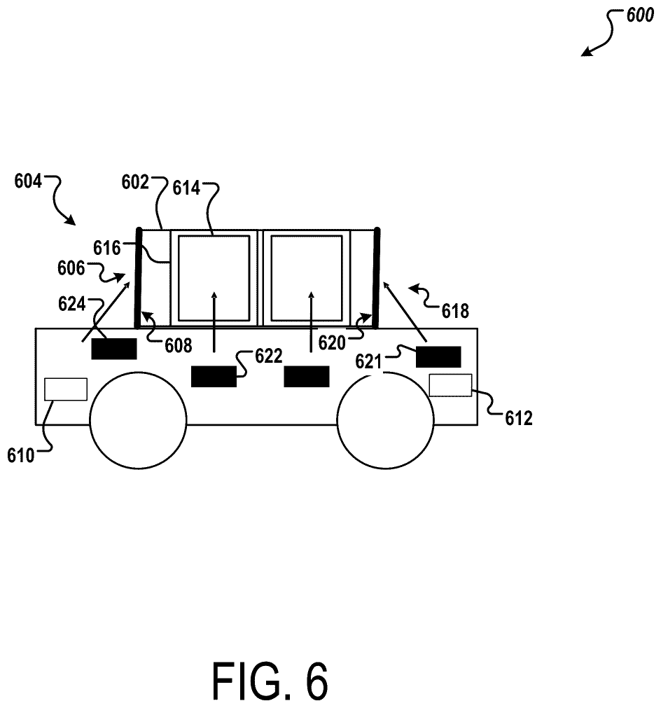

Referring to FIG. 6, a vehicle protection system 600 is implemented to shield a cabin area 602 of a vehicle 604 during collision events. The system 600 may include multiple protective elements designed to prevent debris from entering the cabin area 602 and other areas of the vehicle 604 through various locations (e.g., windows, windshield, etc.).

A hood 606 of the vehicle 604 is configured to move rapidly over a windshield 608 of the vehicle 604 when a collision is detected. In some implementations, the collision is detected based output data determined by a process implemented by a computer 610 that is configured to process data received from one or more sensors 612 implemented on the vehicle 604. The movable hood 606 protection creates a barrier to block debris that might otherwise enter through the windshield 608.

The vehicle protection system 600 also incorporates metal shielding 614 for windows of the vehicle 604 (e.g., a window 616). In some implementations, the metal shielding 614 is stored within doors of the vehicle 604. When activated, the metal shielding 614 may raise rapidly to cover the window 616, providing protection against debris intrusion through the window 616. In some implementations, a separate metal shielding component is activated for each window of the vehicle 604.

For rear protection of the vehicle 604, the system 600 includes a movable element associated with a trunk 618 of the vehicle 604. A top portion of the trunk 618 is configured to move rapidly to cover a rear glass 620 of the vehicle 604 during a collision event. This trunk protection may prevent debris from entering the cabin area 602 through a rear window that includes the rear glass 620.

The protective elements of the system 600 (e.g., the trunk 618, the metal shielding 614, and the hood 606) may be designed to deploy simultaneously when a collision is detected. In some implementations, the sensors 612 on the vehicle 604 detects impact events and trigger the rapid deployment of the various or all of the protective components.

The deployment mechanisms for the protective elements may utilize various actuation methods. In some cases, pneumatic systems may be used to rapidly move the protective components into position. Alternatively, hydraulic actuation or other mechanical methods may be employed to deploy the shielding elements.

The vehicle protection system may be integrated with the vehicle's onboard computer 610 systems. In some implementations, the deployment of the protective elements may be controlled by a central computer unit (e.g., the computer 610) that coordinates the activation of multiple safety features during collision events. For example, the computer 610 can receive sensor data from the sensors 612. Based on output data values as determined by the computer 610, the computer 610 can transmit activation signals to one or more actuators that control protective elements associated with the system 600. For example, the one or more actuators can include a trunk rear glass protector actuator 621, one or more window protector actuators 622, and a hood windshield protective actuator 624.

The protective elements may be designed to store compactly within the vehicle's body panels during normal operation. This compact storage may allow for the integration of the protection system 600 without significantly altering the vehicle's exterior appearance or aerodynamics under normal driving conditions.

In some cases, the protective elements are constructed from materials selected for their strength, lightweight properties, and ability to withstand impact forces. The selection of materials may balance the need for effective protection with considerations of overall vehicle weight and performance.

The vehicle protection system 600 may be designed to work in conjunction with other safety features such as airbags and seat belts. The coordinated deployment of multiple safety systems may provide comprehensive protection for vehicle occupants during collision events.

In some implementations, the protective elements are designed for rapid retraction after deployment, e.g., by associated actuators like the hood windshield protector actuator 624. This feature may allow for easier egress from the vehicle 604 following a collision event, facilitating rescue operations or allowing occupants to exit the vehicle 604 more quickly if necessary.

The integration of multiple protective elements in the vehicle protection system 600 may provide a comprehensive approach to occupant safety during collisions. By creating barriers against debris intrusion through various vehicle locations, e.g., the windshield, windows, and rear window, the system 600 helps reduce the risk of injury from flying objects or shattered glass during impact events.

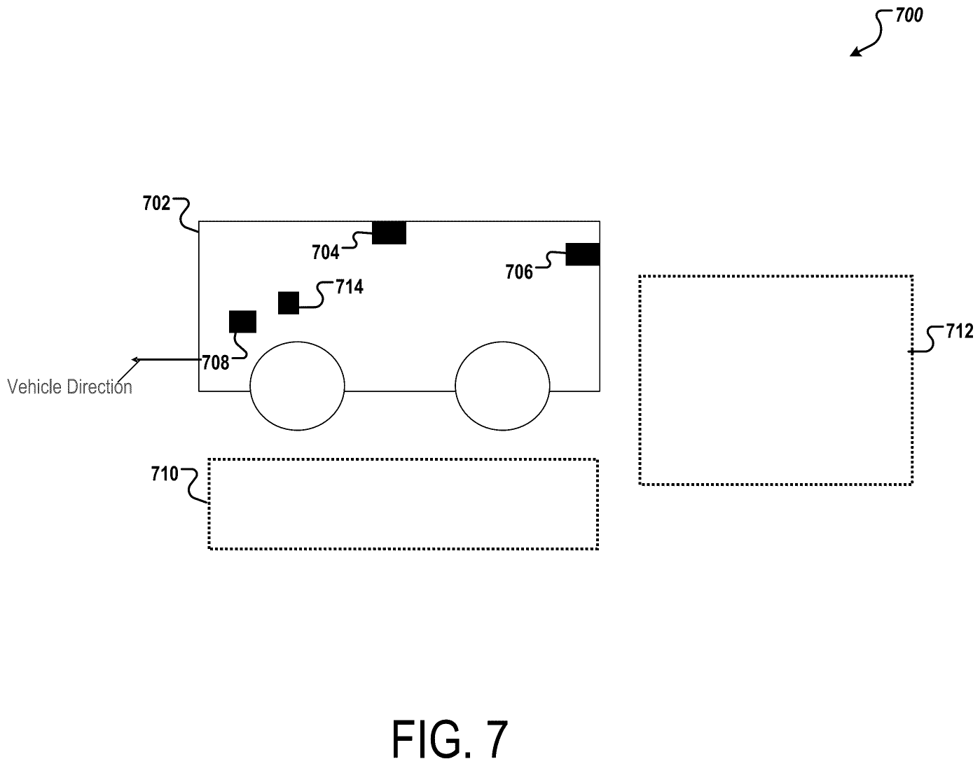

Referring to FIG. 7, an automatic horn system 700 is implemented in a vehicle 702 to enhance safety by alerting nearby drivers of potential collision risks. The system 700 utilizes sensors, e.g., a side sensor system 704 and a rear sensor system 706, positioned on the vehicle 702 to detect approaching vehicles from a sides detection area 710 and rear detection area 712 respectively.

In some cases, the automatic horn system 700 incorporates sensor systems that include a vision system to identify approaching vehicles. The vision system may include cameras or other optical sensors mounted on the sides and rear of the vehicle 702. These sensors may continuously monitor the surrounding areas for other vehicles entering the detection zones (e.g., within the side detection area 710). In some implementations, data recorded by the vision systems are transmitted to a computer 708 disposed within the vehicle 702.

The automatic horn system 700 may be connected to the computer 708 within the vehicle 702. The computer 708 may process input from the vision system or other sensors (e.g., the rear sensor system 706) to analyze the movement and proximity of nearby vehicles. In some implementations, the computer 708 may use algorithms to predict potential collision scenarios based on the relative speeds and trajectories of the detected vehicles.

When the system 700 detects an impending collision risk, it may automatically activate a horn 714 of the vehicle 702. This automated horn activation may serve to alert drivers of approaching vehicles, averting accidents by drawing attention to the hazardous situation.

The sensitivity and activation parameters of the automatic horn system 700 may be adjustable. In some cases, the system 700 is configured to activate the horn 714 only when certain threshold conditions are met, such as a minimum closing speed or proximity of the approaching vehicle. In some implementations, the computer 708 processes data received from sensor systems (e.g., the side sensor system 704, among others) to determine if the certain threshold conditions are met.

In some implementations, a side detection system is positioned along the side of the vehicle 702 to monitor the side detection area 710. A rear detection system may be mounted at the rear of the vehicle 702 to monitor the rear detection area 712.

In some implementations, the side detection system and rear detection system utilize vision technology, such as cameras or other optical sensors. These detection systems may continuously scan their respective areas and transmit data to the computer for processing.

The computer 708 may analyze input from both detection systems to identify potential collision risks. When a risk is detected, the computer 708 may send a signal to automatically activate the horn 714. This automated response may occur more quickly than a human driver could typically react, providing crucial extra seconds of warning in dangerous situations.

The automatic horn system 700 may be particularly beneficial in scenarios where the driver's attention may be divided or where visibility is limited. For example, the system 700 helps alert other drivers during lane changes, when exiting parking spaces, or in heavy traffic conditions where sudden stops are common.

In some cases, the automatic horn system 700 is integrated with other vehicle safety features. For example, the system 700 works in conjunction with blind spot monitoring or rear cross-traffic alert systems to provide both visual and audible warnings when potential hazards are detected.

The implementation of an automatic horn system 700 may contribute to overall road safety by providing an additional layer of collision prevention. By automatically alerting nearby drivers to potential dangers, the system 700 helps reduce the likelihood of accidents caused by driver inattention or limited visibility.

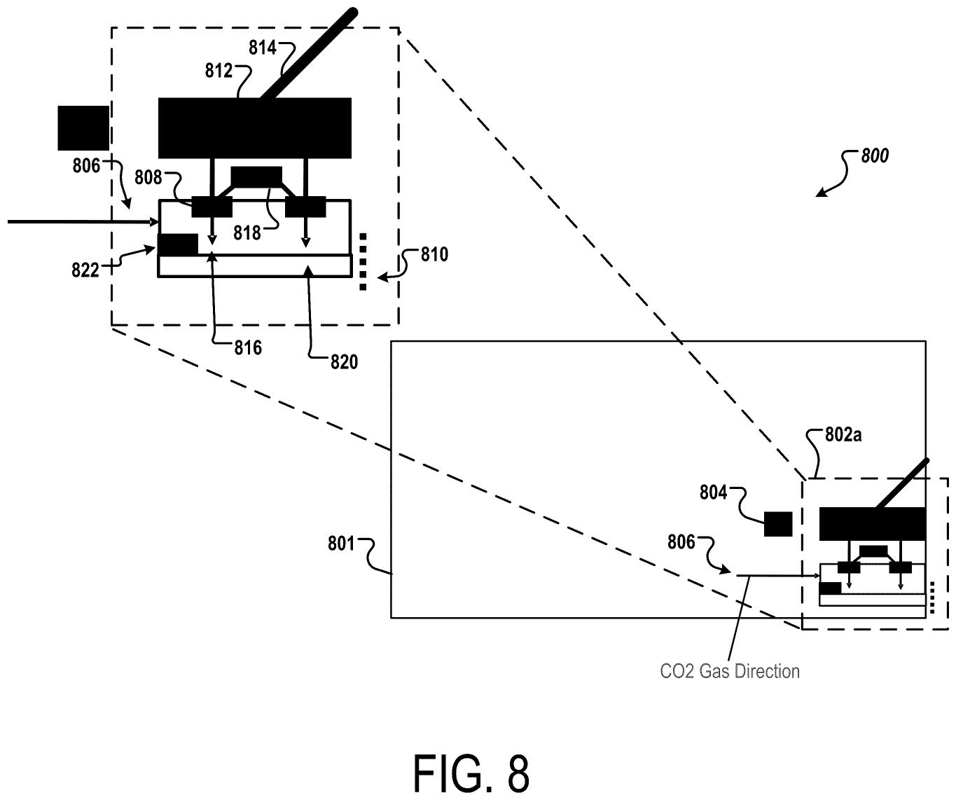

Referring to FIG. 8, a vehicle CO2 mister and air filtration system 800 is implemented to reduce carbon dioxide emissions from vehicle exhaust emitted by a vehicle 801. The system 800 includes a sprayer 808 (also referred to as a mister) positioned in an exhaust system 816 of the vehicle 801. The exhaust system 816 is included in a CO2 collection filtration system 806a. The filtration system 802a is also represented as enlarged representation of the filtration system 802b for ease of description. Components of the filtration system 802a are similar to the components of the enlarged representation of the filtration system 802b. In some cases, the sprayer 808 mists a very small amount of water or another biodegradable chemical into exhaust fumes.

The misting process collects CO2 gas from the exhaust fumes via a CO2 gas entry point 806 into the exhaust system 816, such that the misting process results in a mixture of the CO2 gas and contents of the mist from the sprayer 808. As a result, the mist containing CO2 may exit the exhaust system 816 as droplets 810, while remaining fumes may exit without CO2 gas or reduced CO2 gas. This process helps reduce overall carbon dioxide emissions from the vehicle 801.

In some implementations, the system 800 recycles liquid used for CO2 collection (e.g., liquid formed during the misting process through operation of the sprayer 808). The exhaust system 816 may include a collection mechanism to gather the liquid after dispersion by the sprayer 808. The filtration system 802a(b) includes one or more filters that may then remove CO2 particles from the collected liquid, allowing the filtered liquid to be reused for further CO2 collection.

The filtration system may utilize various types of filters. In some cases, a charcoal filter is employed. Alternatively, other filtering materials or methods are used. The filter may be designed to be replaceable after a certain period of use. In some implementations, the filter may be cleaned and reused multiple times.

The system 800 includes a tank 812 for storing the misting fluid. In some cases, the tank 812 has a conduit 814 positioned next to a fuel conduit that provides an entry point for fuel into a fuel tank of the vehicle 801. This configuration may allow both the fuel tank and mister tank 812 to be filled from the same access point on the vehicle. A selection mechanism, e.g., a switch, may be included at a fuel port to allow the user to choose between filling the fuel tank or the mister tank 812.

The CO2 filtration system 802a(b) may be designed for installation on existing vehicles as an aftermarket product. For example, a vehicle that does not include components of the filtration system 802a(b) can integrate the components at a future time. Alternatively, it may be integrated into a design and manufacture of new vehicles. For aftermarket installations, the system may be fitted over the existing exhaust system, with the filtration system 802a(b) inserted into an exhaust pipe of a vehicle and secured in place.

To connect liquid conduits (e.g., a conduit that directs liquid to the tank 812) to an inserted exhaust filtration system 802a(b), holes may be drilled into an exhaust pipe of a vehicle along its length. The liquid conduits may then connect to the sprayers 808 (e.g., misters) within the exhaust pipe at these holes and also link to the liquid tank 812.

The system 800 may incorporate multiple sprayers (e.g., multiple misters) within the exhaust system 816. These sprayers may be positioned on various sides of the exhaust pipe to ensure comprehensive coverage. In some implementations, a fluid collection system is positioned opposite the sprayers.

An alternative configuration involves vacuuming exhaust air and filtering it without the sprayers. In this case, the exhaust air is vacuumed and then sent through conduits to an air filtration system designed to remove CO2. The filtered air is then released with reduced or no CO2 content.

In some cases, the filtration system 802a(b) is located close to an engine of the vehicle 801 or within the engine itself, rather than in the exhaust system. This positioning may allow for CO2 capture earlier in the emissions process.

The system 800 may be powered by the vehicle's battery. An electric pump 818 may be used to move liquid from the tank 812 to the sprayer 808. The sprayer may also be electrically powered.

To optimize CO2 extraction, the exhaust system 816 and liquid may be heated with a heater 820. The heater 820 used for this purpose may be powered by the vehicle's battery. In some implementations, the system operates without additional heating.

The exhaust system 816 includes a sensor 822 to measure an amount of CO2 gas content within the exhaust fumes within the exhaust system 816. Based on measurements from the sensor 822, the system 800 may adjust a quantity of mist released by the sprayer 808 to optimize CO2 capture efficiency.

A computer 804 may control operations of various components of the system 800, managing factors such as misting quantity, filtration cycles, and heating elements. This computerized control may allow for adaptive performance based on real-time exhaust composition data.

The liquid used for misting by the sprayer 808, stored in the tank 812, and entering the tank 812 by the conduit 814, may vary depending on the specific implementation. Water may be used in some cases, while other biodegradable chemicals or chemicals may be employed in others. The fluid used for misting and/or steam may be a mixture of various chemicals. The system 800 may be designed to produce a very fine mist to maximize the surface area for CO2 capture. The system 800 may additionally or alternatively disperse a steam of the water, biodegradable chemical, or chemical into the exhaust to capture the CO2. A heating device may heat the water, biodegradable chemical, or chemical into steam then the steam may be released through conduits or valves along the length and circumference of the exhaust pipe in various positions.

After misting and/or steam collection or before, the gas or remaining gas may be filtered through an air filtration system then released or processed further. Various air filtration systems may be used, and the air filtration system may have layers of particle collecting materials. The gas may be pumped by an electric pump or fan or vacuumed from the misting and/or steam process into and through the air filtration system. The air filtration system may be separate from the exhaust system, or the filtration materials may be within the exhaust system perpendicular to the exhaust pipe and secured within the exhaust pipe.

The exhaust gas may cycle through the misting and/or steam and/or air filtration multiple times before being released. Sensors controlled by a computer may determine when the gas is sufficiently reduced of CO2 then release the remaining gas.

By integrating CO2 capture and filtration into vehicle exhaust systems, this technology may contribute to reducing the environmental impact of vehicle emissions. The ability to retrofit existing vehicles or incorporate the system into new designs may provide flexibility in addressing carbon dioxide emissions across a wide range of vehicles.

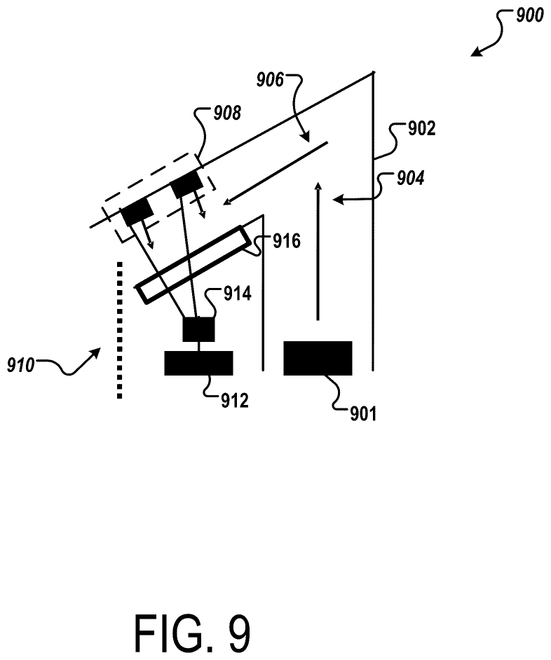

Referring to FIG. 9, a coal plant CO2 mister and air filtration system 900 are implemented to reduce carbon dioxide emissions from coal-fired power plants. The system 900 may include a modified smoke stack configuration designed to facilitate CO2 capture from exhaust gases.

In some cases, a smoke stack 902 is configured to direct coal smoke from burning coal 901 upwards along a first direction 904 and then downwards along a second direction 906. This redirection of exhaust flow may allow for more effective interaction between the exhaust gases and CO2 capture mechanisms.

The system 900 incorporates misters 908 positioned within a downward portion of the smoke stack 902 (e.g., positioned in a section of the system 900 in which the coal smoke travels along the second direction 906). The misters 908 may spray a misting liquid like water or another chemical into the smoke as it passes through this section. The misting process may allow the CO2 gas to be collected in the mist liquid, separating it from the remaining exhaust gases.

In some implementations, the misted liquid containing CO2 exits the smoke stack 902 as liquid droplets 910 or other form, while the remaining exhaust air is released without the captured CO2 gas. This separation helps reduce the overall carbon dioxide emissions from the system 900.

The system 900 includes a tank 912 for storing the misting liquid. A pump 914 is used to deliver the misting liquid from the tank 912 to the misters 908 within the smoke stack 902. In some cases, the misting liquid is heated by a heater device 916 before being sprayed into an exhaust stream traveling along the second direction 906 to optimize CO2 capture efficiency. The misting liquid may alternatively be a steam of the water or chemical and the steam may be used to capture CO2 from the smoke. The misting liquid may be heated into steam by the heating device 916) then released into the smoke stack 902 over or within the smoke through conduits or valves within the smoke stack 902. The conduits or valves for the steam may be along the length and/or circumference of the smoke stack in various positions, releasing the steam at various positions within the smoke stack 902. The steam with captured CO2 may be consolidated into a fluid by cooling the mixture and collected in liquid form, e.g., the droplets 910. Both steam and misting may be used together to capture CO2 from the smoke. For either misting or steam the fluid or steam may be mixed with smoke within the smoke stack 902 to facilitate capture of the CO2 from the smoke. Various mixing mechanisms may be used.

The system 900 may also incorporate an air filtration component as an alternative or complement to the misting process. In this configuration, the exhaust smoke is vacuumed or pumped and directed through an air filtration system designed to remove CO2. The filtered air may then be released with reduced CO2 content. After misting and/or steam collection or before, the gas or remaining gas may be filtered through an air filtration system then released or further processed. Various air filtration systems may be used, and the air filtration system may have layers of particle collecting materials. The filtration system may be designed for periodic replacement or cleaning to maintain optimal performance over time. The gas may be pumped by an electric pump or fan or vacuumed from the misting and/or steam process into and through the air filtration system. The air filtration system may be separate from the smoke stack, or the filtration materials may be within the smoke stack perpendicular to the smoke stack and secured within the smoke stack.

The system may incorporate a CO2 sensor to monitor CO2 levels in the gas. This sensor data may be used to adjust misting parameters, such as spray volume or frequency, to maintain optimal capture performance. The smoke may cycle through the misting and/or steam and/or air filtration multiple times before being released. Sensors controlled by a computer may determine when the smoke is sufficiently reduced of CO2 then release the remaining gas.

In some implementations, the captured CO2-containing liquid is collected and reused within the system. A vacuum or other collection mechanism may gather the liquid after it has interacted with the gases. The collected liquid may then be filtered to remove CO2 particles before being reused for further CO2 capture cycles.

Alternatively, the system may be designed for single-use of the misting liquid or steam. In this case, the CO2-containing liquid is collected and disposed of after a certain number of cycles or when it reaches a specific CO2 concentration threshold.

The coal plant CO2 mister may be integrated with existing smoke stack structures. In some cases, the misting apparatus is installed along the vertical length of the smoke stack (e.g., along the first direction 904 of the smoke stack 902), which can eliminate the need for a downward-oriented section. A downward section may be attached to the top of existing smoke stacks, with the misting sprayers and/or steam release conduits or valves along the length and circumference of the downward section of the smoke stack in various positions.

An alternative configuration involves spraying the mist over a membrane that is permeable to air but impermeable to liquid. This arrangement may allow the gases to pass through the membrane while the mist collects CO2 and is then the liquid is gathered by the membrane for processing or disposal.

In some implementations, the CO2 mister, and/or steam devices, and/or air filtration system are computer-controlled. This may allow for real-time adjustments to system parameters based on exhaust composition, environmental conditions, or power plant operational status.

The captured CO2 may be handled in various ways depending on the specific implementation and local regulations. In some cases, the CO2 is compressed and stored for later use or disposal. Alternatively, the captured CO2 is utilized in industrial processes or for enhanced oil recovery operations.

The coal plant CO2 mister, and/or steam devices, and/or air filtration system may be designed for installation on existing coal plant infrastructure or integrated into the design of new facilities. This flexibility may allow for broader adoption of CO2 reduction technologies across different types and ages of coal-fired power plants.

By implementing such CO2 capture systems, coal plants reduce their environmental impact and comply with increasingly stringent emissions regulations. The ability to retrofit existing plants with these technologies may provide a pathway for continued operation of coal-fired power generation while addressing concerns about carbon dioxide emissions.

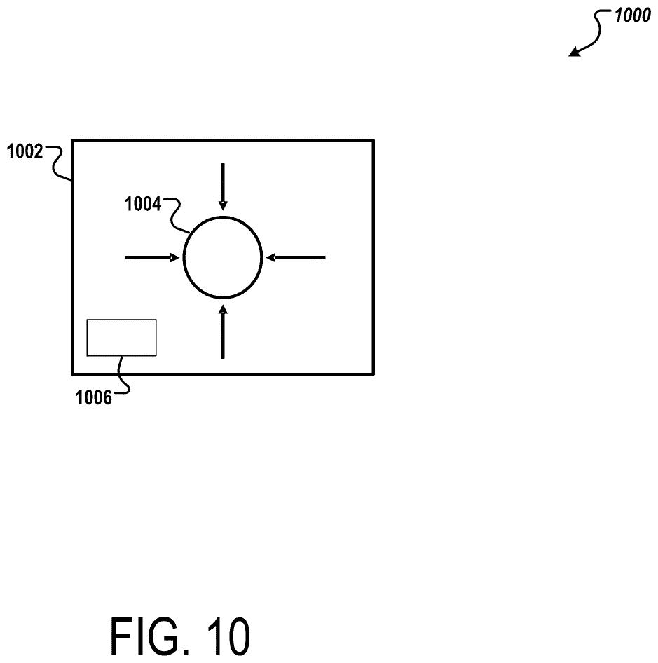

Referring to FIG. 10, a magnetic chassis system 1000 is implemented in a vehicle to enhance structural rigidity and improve safety during collisions. The system 1000 incorporates magnetic elements within a chassis structure 1002 to provide additional reinforcement.

The vehicle's chassis structure 1002 includes a magnetic core 1004 positioned along an interior of the chassis structure 1002. This magnetic core 1004 may be configured as an attractive magnet to surrounding metal of the chassis structure 1002. The magnetic core 1004 may extend through multiple sections of the chassis structure 1002 to provide comprehensive reinforcement. The magnetic core 1004 may be various shapes, widths, and lengths.

The magnetic core 1004 may be designed to attract the surrounding metal of the chassis structure 1002 on multiple sides. This multi-directional magnetic attraction helps increase an overall rigidity of the chassis structure 1002. By magnetically binding components of the chassis structure 1002 together, the system 1000 reduces deformation during collision events.

In some implementations, the magnetic core 1004 is an electromagnet. The use of an electromagnet may allow for variable magnetic strength depending on driving conditions or collision detection and increased reinforcement from increased magnetic strength for improved chassis rigidity. For example, the electromagnet may be off or at a lower strength during normal driving conditions to conserve energy.

The system 1000 includes sensors 1006 to detect potential collision events. When data from the sensors 1006 are processed by a computer to generate an output indicative of an imminent collision, the electromagnet may be rapidly activated to its full strength. This rapid magnetic reinforcement helps fortify the chassis structure 1002 in the moments before and during impact.

In some cases, the magnetic chassis system 1000 works in conjunction with other vehicle safety systems (e.g., automatic braking). For example, the magnetic reinforcement may be coordinated with airbag deployment or other collision mitigation technologies to provide comprehensive occupant protection.

The magnetic elements of the chassis structure 1002 may be arranged in various patterns and geometries within a vehicle structure. These arrangements may be optimized based on specific vehicle design parameters and anticipated collision scenarios. In some implementations, the magnetic reinforcement may be concentrated in areas of the vehicle that are most vulnerable to deformation during impacts.

In addition to the attractive magnetic core 1004, some implementations include repelling magnets surrounding certain components of the chassis structure 1002. These repelling magnets may be positioned to create opposing forces that further enhance the structural integrity of the chassis structure 1002. The surrounding repelling magnet may alternatively be an attracting magnet to the magnetic core 1004 magnet, where both magnets attract and compress the elements of the chassis structure 1002 to further reinforce the chassis elements. The surrounding magnet may be an electromagnet.

Various magnets and electromagnets may be used for the system 1000. Magnets or electromagnets with high structural integrity may be optimal to further increase the strength of the chassis structure 1002 elements.

The magnetic chassis system 1000 may be powered by the vehicle's electrical system. In some cases, a dedicated battery or capacitor may be included to ensure rapid activation of the electromagnets in emergency situations, even if the main vehicle power system is compromised.

The integration of magnetic elements into the chassis structure 1002 allows for lighter overall vehicle construction by reducing a need for chassis materials, while maintaining or improving safety standards. By relying on magnetic forces for additional reinforcement, the system 1000 may reduce the need for some traditional heavy structural components.

In some implementations, the magnetic chassis system 1000 is designed to be selectively activated based on driving conditions. For example, the system 1000 engages more strongly during high-speed driving or when navigating challenging terrain to provide enhanced vehicle stability. Such may be determined by a computer and sensors 1006.

Methods implemented by the magnetic chassis system 1000 are applicable to various types of vehicles, including passenger cars, trucks, and larger vehicles like buses or commercial transport vehicles. The specific implementation may be tailored to the size, weight, and intended use of each vehicle type.

By enhancing the structural integrity of the vehicle chassis structure 1002, the magnetic system may contribute to improved occupant safety during collision events. The additional rigidity provided by the magnetic elements helps maintain the integrity of the passenger compartment, reducing the risk of intrusion during impacts.

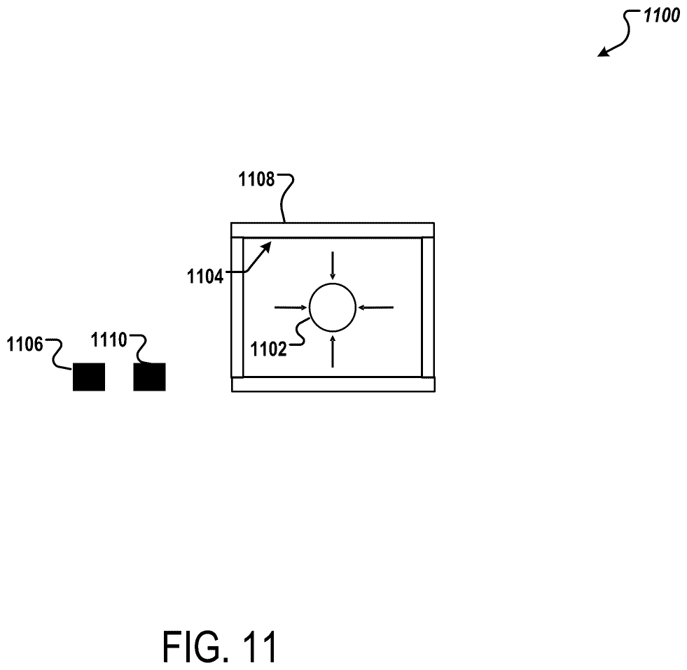

Referring to FIG. 11, a magnetic earthquake stabilizer system 1100 is implemented in a building to enhance structural stability during seismic events. The system 1100 incorporates magnetic elements within the building's frame 1104 (e.g., a metal frame) to provide additional reinforcement and counteract swaying motions caused by earthquakes.

The building's metal frame 1104 includes a magnetic core 1102 positioned within an interior of the metal frame 1104. This magnetic core 1102 may be configured as an attractive magnet to the surrounding metal of the building's metal frame 1104. The magnetic core 1102 may extend through multiple sections of the metal frame 1104 to provide comprehensive reinforcement throughout the structure.

The magnetic core 1102 is designed to attract the metal frame 1104 on multiple sides of the magnetic core 1102, as illustrated in FIG. 11. This multi-directional magnetic attraction helps increase an overall rigidity of the building structure. By magnetically binding the metal frame 1104 components together, the system 1100 reduces swaying and deformation during seismic events.

In some implementations, the magnetic core 1102 is an electromagnet. The use of an electromagnet may allow for variable magnetic strength depending on an intensity of detected seismic activity and may provide increased magnetic reinforced from increased magnetic strength of the electromagnet. For example, the electromagnet may be off or at a lower strength during normal conditions to conserve energy.

The system 1100 includes sensors 1106 to detect seismic activity. Such sensors may be positioned at a distance from the building. When these sensors identify an earthquake (e.g., based on detection of seismic activity via pressure sensors), the electromagnet may be rapidly activated to its full strength. This rapid magnetic reinforcement helps fortify the building structure as seismic waves begin to impact the building.

In some cases, the magnetic earthquake stabilizer system 1100 works in conjunction with other building safety systems. For example, the magnetic reinforcement may be coordinated with other seismic mitigation technologies to provide comprehensive structural protection.

In some implementations, the metal frame 1104 includes Magnetic elements, which are arranged in various patterns and geometries within the building structure. These arrangements may be optimized based on the specific building design and anticipated seismic scenarios. In some implementations, the magnetic reinforcement is concentrated in areas of the building that are most vulnerable to swaying during earthquakes.

In addition to the attractive magnetic core 1102, some implementations include repelling or attracting magnets surrounding certain metal frame elements or all frame elements. The repelling magnets may be positioned to create opposing forces that further enhance the structural integrity of the frame during seismic events. When the surrounding magnets are attracting magnets, they may be attracting the magnetic core, where both magnets attract to compress the frame, reinforcing the fame. The surrounding magnet may be an electromagnet.

The magnetic earthquake stabilizer system 1100 may be powered by the building's electrical system. In some cases, a dedicated backup power source is included to ensure rapid activation of the electromagnets during earthquakes, even if the main power system is compromised.

The system 1100 includes exterior magnets 1108 on the building metal frame 1104. These exterior magnets 1108 may have a repelling force to the metal frame 1104 and/or an interior magnet (e.g., the magnetic core 1102). The exterior magnets 1108 and magnetic core may be electromagnets. During an earthquake, these repelling exterior magnets 1108 and/or the magnetic core 1102 may push the metal frame 1104 in an opposite direction of the building's sway at timed intervals. Such may be done by increasing the magnetic strength of either the magnetic core 1102 or exterior magnets 1108, then alternating, and may be done by varying the magnetic strength along the length of either the exterior magnets 1108 or magnetic core 1102. The intervals of varying magnetic strength and location of magnetic force may be calibrated by data collected by the sensors 1106 to effectively counteract the seismic motion.

The system may be computer-controlled by a computer 1110, allowing for precise coordination of magnetic forces based on real-time seismic data. The computer may analyze input from the sensors 1106 throughout the building to optimize the response of the magnetic stabilizer system 1100. The sensors 1106 are communicatively coupled to the computer 1110, either by a wired or wireless communication channel. One or more components of the system 1100 (e.g., the magnetic core 1102) are communicatively coupled to the computer 1110 and receive signals in response to data received from the sensors 1106.

In some cases, the magnetic earthquake stabilizer system 1100 is designed with multiple layers of protection. For example, the system 1100 employs both fortification magnets to increase structural rigidity and pushing magnets to actively counteract swaying motions. This multi-layered approach may provide more comprehensive protection against various types of seismic activity.

The magnetic earthquake stabilizer system 1100 is applicable to various types of buildings, including residential structures, office buildings, and larger structures like bridges or towers. The specific implementation may be tailored to the size, height, and structural characteristics of each building type.

By enhancing the structural integrity of the building metal frame 1104, the magnetic earthquake stabilizer system 1100 may contribute to improved occupant safety during seismic events. The additional rigidity and active stabilization provided by the magnetic elements (e.g., the magnetic core 1102) helps maintain integrity of the building, reducing the risk of structural failure or collapse during earthquakes.

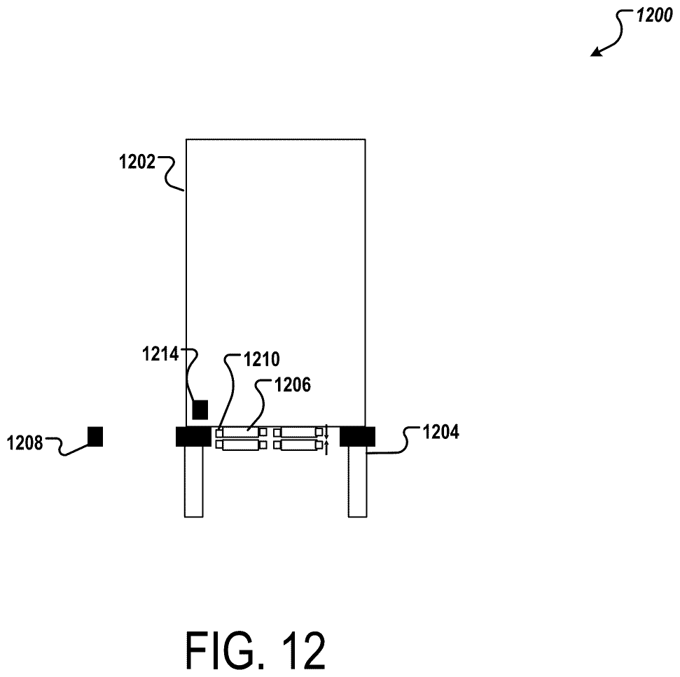

Referring to FIG. 12, a magnetic earthquake stabilizer foundation system 1200 is implemented to protect a building 1202 from seismic forces during earthquakes. The system 1200 may utilize electromagnetic suspension to temporarily decouple the building 1202 from its foundation 1204 during seismic events.

The system 1200 includes very strong repelling electromagnets 1206 aligned within the foundation 1204 of the building 1202, where each vertical element of the foundation 1204 (e.g., a pillar of the foundation 1204 that couples the building 1202 with the ground) or other elements of the foundation may have two repelling electromagnets aligned along each vertical element of the foundation with the electromagnets facing each other and touching when not activated, where each electromagnet may be perpendicular to the vertical elements of the foundation, and where each electromagnet pair may be horizontally aligned. These electromagnets may be configured to create a repelling magnetic field between the building and its foundation when activated.

The system incorporates an earthquake sensor 1208 to detect seismic activity. The sensor 1208 is positioned at a distance from the building 1202. When an earthquake is detected, the electromagnets 1206 are activated, causing the building 1202 to decouple from its foundation 1204. The repelling magnetic forces generated by the electromagnets 1206 may suspend the building 1202 above its foundation 1204, isolating the building 1202 structure from ground movements.

The system 1200 includes alignment electromagnets 1210 positioned around the repelling electromagnets 1206. These alignment electromagnets 1210 may have a weaker attractive magnetic force compared to the repelling electromagnets 1206. The alignment electromagnets 1210 help keep the building 1202 properly aligned with its foundation 1204 while suspended (e.g., during a detected earthquake event). When the repelling electromagnets 1206 activate, the alignment electromagnets 1210 may also activate. After the earthquake, both the repelling electromagnets 1206 and the alignment electromagnets 1210 may deactivate and the building 1202 may recouple with its foundation 1204. Other stabilization systems may be used to keep the alignment of the building 1202 with its foundation 1204 when the system 1200 is activated.

The repelling electromagnets 1206 have connectors that mechanically secure the repelling electromagnets 1206 together when the system 1200 is not activated. The connectors may be perpendicular to the repelling electromagnets 1206 and go through the repelling electromagnets 1206 and secure the repelling electromagnets 1206 together and to the foundation 1204 on either side of the repelling electromagnets 1206. The connectors may be controlled by a computer 1212 and associated software executed by the computer 1212. The connectors may uncouple the repelling electromagnets 1206 during an earthquake when the system 1200 is activated.

The magnetic earthquake stabilizer foundation system 1200 may, additionally or alternatively to the alignment electromagnets 1210, include tethering wires to secure the building 1202 to the ground when the electromagnets 1206, 1210 are activated. These tethering wires provide additional stability and prevent excessive lateral movement of the suspended building 1202.

In some cases, the system 1200 is designed to automatically deactivate the electromagnets 1206, 1210 after the earthquake has subsided. This deactivation allows the building 1202 to recouple with its foundation 1204, returning to its normal structural configuration.

The system 1200 may be controlled by the computer 1214 that manages the activation and deactivation of the electromagnets 1206, 1210 based on input from the earthquake sensor 1208. The computer 1214 may also monitor a position of the building 1202 (e.g., via a camera system or other position-sensitive sensors) and adjust electromagnetic fields associated with the electromagnets 1206, 1210 as needed to maintain proper alignment during suspension.

In some implementations, the system 1200 includes a power backup to ensure operation even if a main power supply of the system 1200 is disrupted during an earthquake. This backup power source may be designed to provide sufficient energy to maintain electromagnetic suspension for the expected duration of seismic events. The building's electrical system may supply electricity to the electromagnets.

The magnetic earthquake stabilizer foundation system 1200 may be customized based on specific characteristics of each building, such as its size, weight, and structural design. The strength and arrangement of the electromagnets may be tailored to provide optimal suspension and stability for different types of structures.

In some cases, the system 1200 incorporates dampening mechanisms to reduce any residual vibrations or oscillations that may occur while the building 1202 is suspended. These dampeners help ensure a smoother isolation effect during seismic events.

The magnetic earthquake stabilizer foundation system 1200 may be designed for integration into new construction projects or retrofitted to existing buildings. In retrofit applications, the system 1200 may require modifications to the existing foundation to accommodate the electromagnetic components.

By temporarily decoupling the building 1202 from its foundation 1204 during earthquakes, the magnetic earthquake stabilizer foundation system 1200 reduces transmission of seismic forces to the structure of the building 1202. This isolation effect helps protect the building 1202 and its occupants from the damaging effects of ground movements during seismic events.

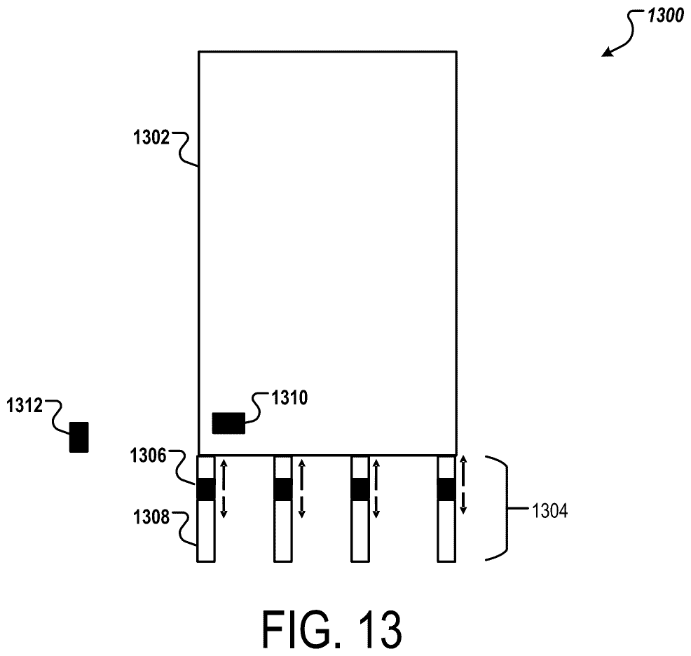

Referring to FIG. 13, an earthquake expander system 1300 is implemented in a building 1302 to counteract swaying motion of the building 1302 during seismic events. The system 1300 includes, for each vertical component of a foundation 1304 of the building 1302, one or more expanders 1306 connecting metal frame 1308 components within the building's foundation 1304.

In some cases, the expanders 1306 are configured to move the metal frame 1308 of the building 1302 in intervals to counteract the swaying motion of the building 1302 during an earthquake. The system 1300 incorporates expanders 1306 positioned on multiple or all sides of the building 1302 and at various locations within the area of the foundation 1304 at the foundation level, with all expanders 1306 horizontally aligned. The expanders 1306 may be along vertical elements of the foundation 1304. The expanders 1306 may be structurally secured to elements of the foundation 1304. All vertical elements of the foundation 1304 may include expanders similar to the expanders 1306. Each expander 1306 includes an extending portion within the expander to expand and contract, creating movement within the element of the foundation 1304. During an earthquake, the expanders 1306 in different locations of the building 1302 either expand or contract, where when the expanders 1306 on one side of the building 1302 expand, the expanders 1306 on the other side of the building 1302 contract, where the expanding or contracting locations of the expanders 1306 are calibrated by a computer 1310 from data in response to measurements by sensors 1312 of the earthquake wave and movement of the building 1302.

The computer 1310 and sensors 1312 may result in a control of the expanders 1306, which may be operational during earthquake events. The expanders 1306 may connect to the building's foundation 1304 and may be actuated through pneumatic, hydraulic, or other mechanical methods.

The system includes the earthquake sensor 1312 positioned near the foundation 1304 or at a distance from the building 1302 to detect seismic activity. The sensor 1312 communicates with the computer 1310 that controls timing and movement of the expanders 1306.

In some implementations, the building 1302 structure includes a metal frame that extends upward from the foundation 1304, with the expanders 1306 positioned to provide stabilizing force in multiple directions. The foundation 1304 includes expanders 1306 that allow for controlled movement of the building 1302 structure to offset earthquake forces.

The expanders 1306 are calibrated by sensors (e.g., the sensor 1312 in addition to other sensors utilized during a calibration procedure) to effectively counteract the seismic motion. The computer 1310 analyzes input from multiple sensors (e.g., including the sensor 1312) throughout the building 1302 to optimize the response of the expander system 1300.

In some cases, the earthquake expander system 1300 is designed with multiple layers of protection. For example, the system 1300 may employ both vertical and horizontal expanders to address different types of seismic movements.

The expanders 1306 may be designed to operate in a coordinated manner, as controlled by the computer 1310, with each expander (e.g., the expanders 1306) adjusting its expansion or contraction amount based on the overall building movement detected by the sensor 1312 or from the measurement of the earthquake wave from the sensor 1312 at a distance from the building 1302. This coordinated action helps maintain the building's stability during complex seismic events.

Techniques associated with the earthquake expander system 1300 are applicable to various types of buildings, including residential structures, office buildings, and larger structures like bridges or towers. The specific implementation may be tailored to the size, height, and structural characteristics of each building type.

In some implementations, the expanders 1306 incorporate shock-absorbing materials or mechanisms to further dampen seismic forces. These elements help dissipate energy and reduce the overall impact of earthquake movements on the building 1302 structure.

The system 1300 may include safety mechanisms to prevent over-expansion or over-contraction of the expanders 1306. These safeguards help ensure that the building 1302 remains within safe structural limits even during extreme seismic events.

In some cases, the earthquake expander system 1300 is designed to work in conjunction with other seismic protection technologies, such as foundation isolation systems, as described in relation to FIG. 12, or tuned mass dampers. The integration of multiple protection strategies provide more comprehensive earthquake resistance for buildings.

By actively counteracting building sway through controlled expansion and contraction, the earthquake expander system 1300 contributes to improved structural stability during seismic events. The system's 1300 ability to respond dynamically to earthquake forces helps maintain the integrity of the building 1302, reducing risk of structural damage or collapse during earthquakes.

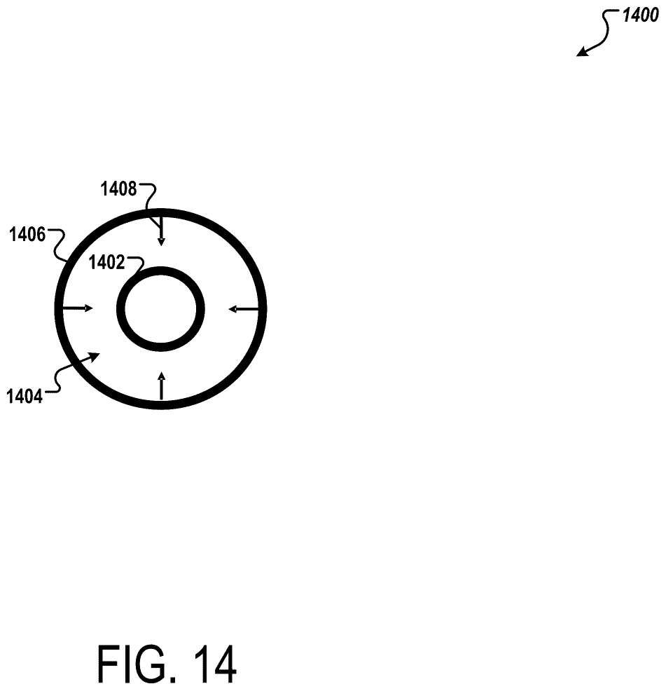

Referring to FIG. 14, a configuration of a magnetic wire 1400 is implemented to enhance electricity transfer efficiency between an electrical source and an electrical drain that are coupled by the wire 1400. The wire 1400 includes multiple components arranged in a concentric structure, as illustrated in FIG. 14, to help contain electrical current within a portion of a cross-section of the wire 1400 and to direct a propagation of electrical current along a length of the wire 1400.

In some cases, the magnetic wire 1400 includes a central magnetic core 1402 positioned at a center of the wire 1400 assembly. This magnetic core 1402 may be configured as an attracting magnet (e.g., it attracts metal in a vicinity of the magnetic core 1402). The magnetic core 1402 is positioned along the length of the magnetic wire 1400 and centered in an interior portion of the wire 1400. The magnet core 1402 has a diameter of 0.001% to 60% or other amounts, of a diameter of the magnetic wire 1400. Surrounding the magnetic core 1402, a copper wire 1404 or other electrical conductor is positioned to carry the electrical current along the length of the wire 1400 from the source to the drain.

An exterior of the wire 1400 assembly include a magnetic lining 1406 that extends along the length of the wire 1400. This magnetic lining 1406 may be configured as a repelling magnet (e.g., it repels metal or other repelling magnetics in a vicinity of the magnetic lining 1406). The magnetic lining 1406 surround the copper wire 1404 or electrical conductor portion of the assembly. The magnetic lining 1406 has a diameter between 0.001% and 60% or other amounts of the diameter of the magnetic wire 1400. The magnetic wire 1400 includes either the exterior magnetic lining 1406, the magnetic core 1402, or both the exterior magnetic lining 1406 and magnetic core 1402.

As illustrated in FIG. 14 with a cross-sectional view of an exemplary magnetic wire configuration the magnetic core 1402 is positioned at the center of the cross-section of the magnetic wire 1400, surrounded by the copper wire 1404 or electricity-carrying portion, which is in turn encased by the magnetic exterior lining 1406.

Magnetic field directions (e.g., direction 1408) within the wire assembly may be arranged to affect the electrical current flow. In some implementations, the central magnetic core 1402 generates an attractive magnetic field, while the exterior magnetic lining 1406 may produce a repelling magnetic field. This configuration of opposing magnetic fields helps contain the electrical current within the copper wire 1404 or another conductor.

By incorporating magnetic elements into the wire 1400 structure, the magnetic wire design reduces electricity loss during transmission. The repelling magnetic field generated by the exterior lining 1406 and/or the attracting magnetic field generated by the magnetic core 1402 helps keep the electrical current concentrated within the copper wire 1404 or other conductor, reducing or minimizing leakage or dissipation. The magnet(s) of the magnetic wire 1400 compresses electricity within the magnetic wire 1400, allowing for a higher density of electricity to be transferred within the magnetic wire 1400 and higher electricity amounts to be transferred from the source to the drain.

In some cases, the magnetic core 1402 and exterior lining 1406 are composed of permanent magnets. Alternatively, electromagnets are used to allow for adjustable magnetic field strengths. When electromagnets are used, electricity from the magnetic wire supplies electricity to the electromagnets. Various permanent magnets and electromagnets may be used for the magnetic wire 1400. The specific materials and magnetic strengths may be selected based on the intended application and desired level of electricity containment.

The magnetic wire 1400 configuration is applicable to various electricity transmission scenarios, from small-scale electronics to larger power distribution systems. The design may be scaled and adapted to suit different voltage levels and current capacities while maintaining the core principle of using magnetic fields to enhance electricity transfer efficiency.

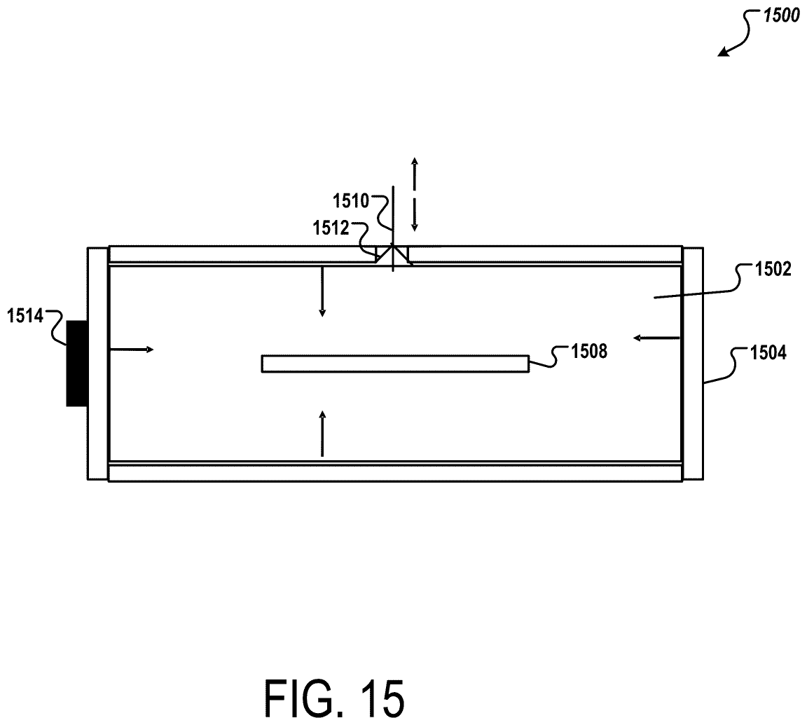

Referring to FIG. 15, an electricity density battery 1500 is implemented to increase energy storage capacity through magnetic compression of electrical energy. The battery 1500 may utilize a combination of conductive materials and magnetic elements to achieve higher energy density storage capabilities.

In some cases, the electricity density battery 1500 includes a cube-shaped copper component 1502 positioned at the center of the battery 1500. The copper component 1502 serves as the primary storage medium for electrical energy within the battery 1500. Other conductive materials may be used instead of copper to store electricity.

Surrounding the copper component 1502, repelling magnets 1504 are arranged to compress electricity within the copper component 1502. These repelling magnets 1504 are configured to create a magnetic field that exerts pressure on the electrical charge contained within the copper component 1502, increasing energy density of the stored electricity within the copper component 1502.

An attracting magnet 1508 is positioned at the core of the battery 1500 within the copper component 1502. This central attracting magnet 1508 works in conjunction with the surrounding repelling magnets 1504 to further enhance the compression effect on the stored electrical energy within the copper component 1502.

As illustrated in a side cross-sectional view of the battery 1500 in FIG. 15, a copper wire 1510 extends from the copper component 1502 to a region outside of the surrounding repelling magnets 1504. This copper wire 1510 is surrounded by an inverse cone magnet 1512 that aligns on one side with a magnet of the surrounding repelling magnets 1504.

The copper wire 1510 serves dual purposes within the battery 1500. When charging the battery 1500, electricity enters the copper component 1502 through the copper wire 1510. During discharge, electricity is extracted from the battery 1500 through the same copper wire 1510.

The inverse cone magnet 1512 surrounding the copper wire 1510 helps control a flow of electricity into and out of the battery 1500. In some implementations, the magnetic strength of the inverse cone magnet 1512 is adjustable to regulate a quantity of electricity entering or exiting the battery 1500, where the inverse cone magnet 1512 may be an electromagnet. Other electricity release systems may be used.

The surrounding repelling magnets 1504 serve to compress electrical energy (e.g., re-locate electrons within the copper component 1504 closer to a center portion of the battery 1500), thus increasing an energy density of electricity stored within the copper component 1502. By exerting magnetic pressure on the copper component 1502, the surrounding repelling magnets 1504 allows for a higher concentration of electrical charge to be contained within a given volume of a conductive material.

In some cases, the magnets used in the electricity density battery (e.g., the surrounding repelling magnets 1504 and the attracting magnet 1508) are permanent magnets. Alternatively, electromagnets are employed to allow for variable magnetic field strengths. The use of electromagnets provides additional control over the compression and energy storage processes. The electricity within the electricity density battery supplies electricity to the electromagnets. Various permanent magnets and electromagnets may be used for the electricity density battery.

When electromagnets are used, when charging the electricity density battery 1500 with electricity the surrounding repelling magnets 1504 (implemented as electromagnets with variable magnetic field strength) may have a higher magnetic strength to increase the compression of the electricity within the copper component 1502. While storing the electricity within the electricity density battery 1500 (e.g., during a time period in which current is not entering or exiting the battery 1500 through the copper wire 1510) the surrounding repelling magnets 1504 (implemented as electromagnets with variable magnetic field strength) may have less magnetic strength than when filling with electricity, to reduce energy usage.

The electricity density battery 1500 incorporates a control system implemented by a computer 1514 with associated software that is executed by the computer 1514 to control and manage the charging, storage, and discharging processes of the battery 1500. This control system may adjust the magnetic fields generated by the various magnetic components of the battery 1500 to optimize charging, storage, and discharging based on current battery conditions and power demands. The control system may control the magnetic strength of the electromagnets when charging the electricity density battery 1500.

In some implementations, the electricity density battery 1500 includes multiple copper components and magnet arrangements within a single battery unit. This configuration allows for increased overall energy storage capacity while maintaining the benefits of magnetic compression for each individual storage element.

The electricity density battery 1500 design is scalable to accommodate various energy storage requirements. Smaller versions may be suitable for portable electronic devices, while larger implementations are relevant for grid-scale energy storage applications.

By utilizing magnetic fields to compress electrical energy within a conductive medium, the electricity density battery 1500 achieves higher energy storage densities compared to conventional battery technologies. This increased storage capacity contributes to the development of more efficient and compact energy storage solutions for a wide range of applications.

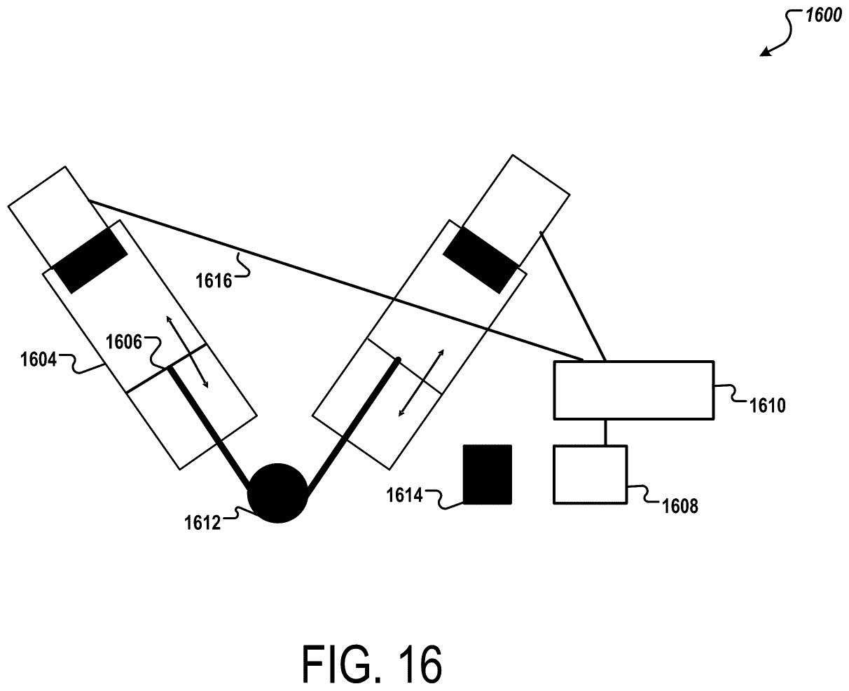

Referring to FIG. 16, a pneumatic engine and air compressor system 1600 is implemented to generate power using compressed air. The system 1600 includes a pneumatic engine portion with cylinders 1604 containing pistons 1606 that are actuated by compressed air bursts from an air compressor 1608 and a compressed air tank 1610.

In some cases, the pistons 1606 is arranged in a configuration similar to conventional combustion engines, with a crankshaft and aligned pistons. The pistons 1606 connect to a central crankshaft 1612 which rotates as the pistons 1606 move within the cylinders 1604.

An air release mechanism, e.g., a compressed air conduit 1616, for the compressed air is at the top of each cylinder 1604, where a compressed air burst is released from the air release mechanism into the cylinder 1604 to exert pressure and force on the piston 1606 moving the piston 1606 and turning the crankshaft 1612. Each cylinder 1604 has a valve or other air release system to discard air from the cylinder after an air burst moves the piston. The cycle of air burst release repeats to power the engine. Each cylinder 1604 is airtight during the air burst release.

The system 1600 incorporates compressed air conduits that deliver compressed air from the air compressor 1608 and/or the compressed air tank 1610 to the cylinders 1604. In some implementations, each cylinder 1606 has its own dedicated air compressor. Alternatively, a single air compressor supplies compressed air to multiple cylinders through a network of conduits, as illustrated in FIG. 16.

The system 1600 includes the tank 1610 for storing compressed air. The compressed air flows from the air compressor 1608 to the tank 1610, and then from the tank 1610 to the engine cylinders 1604 via the compressed air conduit 1616. In some cases, each cylinder 1606 has its own dedicated compressed air tank.

The force of the compressed air bursts may be varied by the system 1600 to change an output power of the system 1600, in which the output power is related to speed of the piston 1606 moving within the cylinder 1604. Additionally, a timing of the compressed air bursts may be adjusted to control the speed and power of the engine.

The system 1600 includes a computer 1614 to control operation of the pneumatic engine, the air compressor(s) 1608, and tank(s) 1610 when used. The computer 1614 may manage the timing and intensity of compressed air bursts, as well as the overall coordination between the air compressor 1608, storage tank 1610, and other engine components. The computer 1614 may use software.

The pneumatic engine may be designed for use in various types of vehicles. The system 1600 may be powered by electricity, with a battery supplying power to the air compressor 1608 and control systems, as implemented by the computer 1614. The battery may be the vehicle's battery.

In some cases, the air compressor 1608 is an electric air compressor. The use of the electric air compressor allows for more precise control over air pressure and flow rates compared to mechanically driven compressors. Various types of air compressors may be used.

The pneumatic engine offers potential advantages in terms of emissions, as it does not rely on combustion of fossil fuels to generate power. This may make the system 1600 suitable for applications where reduced environmental impact is a priority.

The system 1600 may be designed with safety features to manage the high-pressure air used to drive the piston(s) 1606. These safety features may include pressure relief valves, overpressure sensors, and emergency shutdown mechanisms to prevent damage to the engine or injury to operators in case of malfunction.

In some implementations, the pneumatic engine is designed to recover and reuse some of the compressed air after it has driven the piston(s) 1606. This recycling of air helps improve the overall efficiency of the system 1600 by reducing the workload on the air compressor 1608.

The system 1600 that includes the pneumatic engine and air compressor 1608 may be scalable to different sizes and power outputs. Smaller versions are suitable for light vehicles or portable power generation, while larger implementations are relevant to industrial or commercial applications.

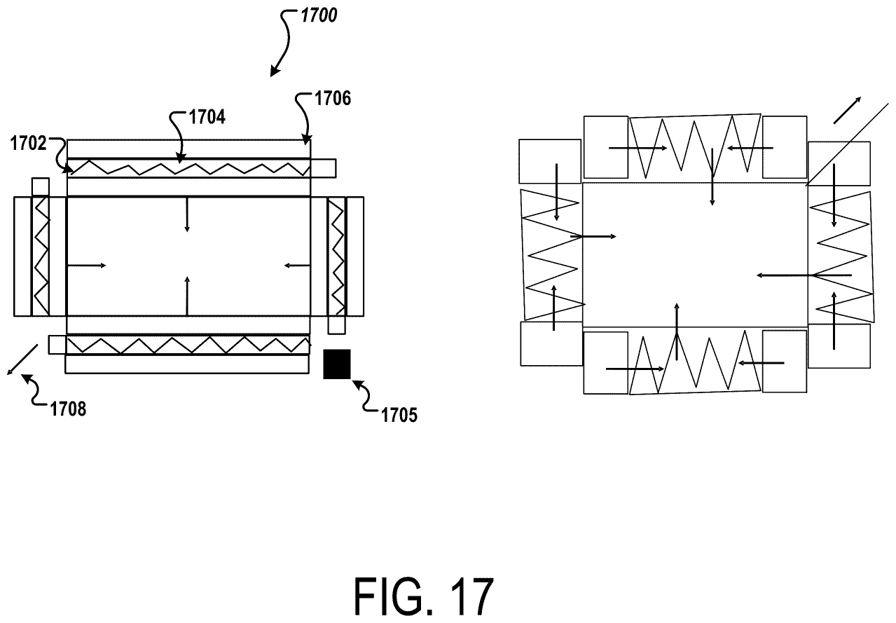

Referring to FIG. 17, a generator system 1700 is implemented to produce continuous electrical power through various configurations of magnetic and electrical components. The system 1700 aims to harness magnetic interactions and electrical phenomena to generate ongoing energy output.

The generator system 1700 utilizes a copper coil 1702 and magnet arrangement. The system 1700 includes the copper coil 1702 that is positioned around a magnet 1704 of the magnet arrangement, where either the magnet 1704 or the copper coil 1702 is configured to spin at high speed around a respective axis (e.g., an axis of the copper coil 1702, which coincides with a longitudinal axis of the magnet 1704). An electric motor 1705 is used to initiate and maintain the spinning motion of the copper coil 1702 and the magnet 1704.

The spinning motion of the copper coil 1702 and/or magnet 1704 induces electrical current in the copper coil 1702 through electromagnetic induction. In some implementations, the electricity generated by this process is used to power the electric motor 1705 that drives a spinning component of the copper coil 1702 and/or magnet 1704, creating a potentially self-sustaining system.

The system 1700 includes permanent magnets 1706 surrounding the copper coil 1702. The system 1700 is configured for electricity to flow along a direction 1708. Another illustration of a generation system 1750 that includes copper coils and magnetic elements is illustrated in FIG. 17.

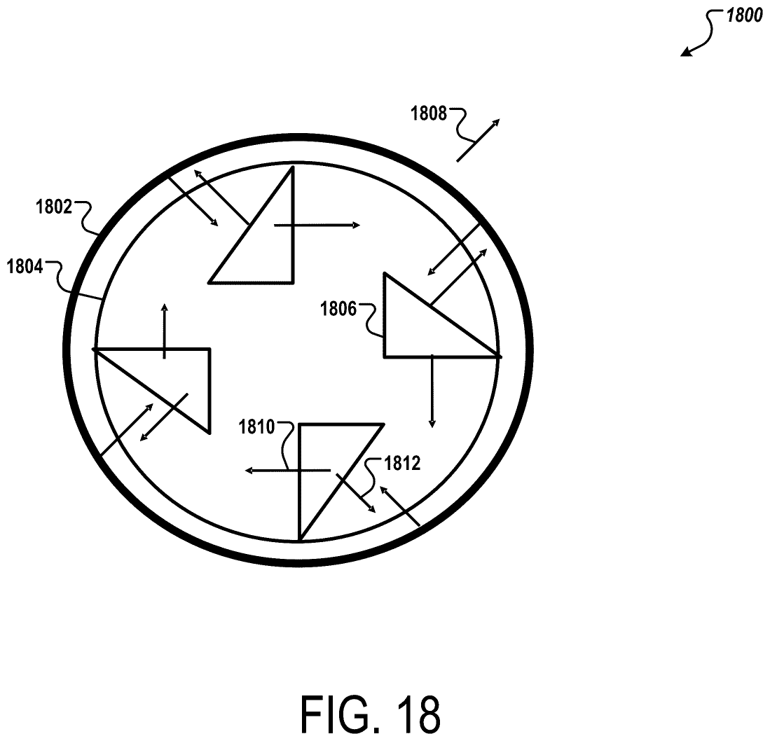

Another generator design system 1800, as illustrated in FIG. 18, incorporates a spiral-shaped magnet configuration. The system 1800 includes a magnet 1802 formed into a three-dimensional spiral shape, with a copper coil 1804 surrounding the spiral magnet 1802. The copper coil 1804 is arranged to spin freely around the spiral magnet 1802 while being constrained from moving side to side or up and down.

In this configuration, the magnetic forces of the spiral magnet 1802 attracts the copper coil 1804, causing the coil 1804 to spin around the spiral magnet 1802. As the copper coil 1804 moves through the magnetic field of the spiral magnet 1802, it harvests electricity through electromagnetic induction.

In some implementations, the system 1800 is not configured in a spiral configuration, but instead includes repelling wedge magnets (e.g., a wedge 1806) on the spiral circle with a surrounding repelling spiral magnet 1802 to the faces of the wedge magnets 1806. A change of magnetic force on the wedge magnets spins the spiral magnet 1802. In some cases, a magnet wire is not included, and alternatively, the surrounding circle magnet 1802 has repelling wedge magnets facing inwards and the spiral has repelling spiral magnet wire to the wedge magnets. The wedge magnets 1806 may be permanent magnets. The wedge magnets 1806 and wire magnets (e.g., the magnet 1802) may be electromagnets. Some of the electricity generated by the device may be supplied to the electromagnets. A direction 1808 indicates a direction of electricity flow, a direction 1810 indicates a direction that the system 1800 spins, and a direction 1812 indicates a magnetic field direction.

Another generator concept involves a configuration of copper wire and magnetic wire arranged in a spiral pattern. The spiral of copper and magnetic wire is formed into a circular shape and surrounded by a repelling magnet circle.

The surrounding repelling magnet circle may be designed with decreasing magnetic strength around its circumference. This variation in magnetic force causes the spiral circle of copper and magnetic wire to move in a circular motion. As the spiral circle moves, electrons are captured by the copper wire from the surrounding magnet.

In some implementations, multiple copper wire and magnet wire spirals are arranged together to increase the overall energy generation capacity of the system. The specific geometry and arrangement of the wire spirals and surrounding magnets may be optimized to enhance the electron capture process and overall energy output.

Some generator designs may utilize melted materials to generate electricity. In one implementation, copper and magnets are melted and mixed together to form a fluid mixture. The melted fluid is contained within an enclosure surrounded by an electric heater.

The fluid mixture is mechanically mixed, causing movement of the melted copper in relation to the melted magnets. This relative motion between the conductive copper and magnetic materials generates electrical current, which may be harvested from the enclosure.

In some cases, the electricity generated from such a system is used to power the electric heater and mixer, with excess electricity available for other purposes. The device may be scaled to different sizes, from small versions for portable electronics to larger implementations for supplying electricity to utility grids.

These generator designs aim to create systems that can produce ongoing electrical power through various configurations of magnetic and electrical components.

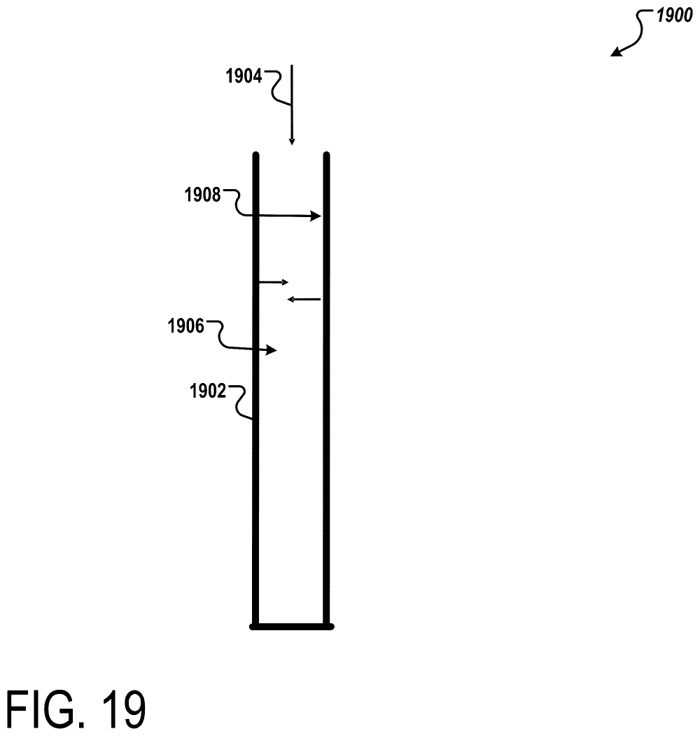

Referring to FIG. 19, a heat setting construction system 1900 is implemented to create structural elements using a mold 1902 and a heat-activated material poured into the mold 1902 from a pour direction 1904. The system 1900 utilizes a mold 1902 designed to contain liquid metal 1906, e.g., poured into the mold 1902 from the pour direction 1904 and contained within the mold 1902, which is externally heated by heating elements 1908 of the mold 1902, to set the liquid metal 1906 within the mold 1902 into a rigid form. The liquid metal 1906 may be liquid at room temperature.

In some cases, the mold 1902 is configured to provide external heat via the heating elements 1908 to the liquid metal 1906, causing the liquid metal 1906 to solidify and maintain a shape, as defined by a shape of the mold 1902. Once the liquid metal 1906 has set, the mold 1902 is removed from the solidified liquid metal 1906, leaving a rigid structural element.

Alternatively, the liquid metal 1906 is added to the mold 1902 in solid or granular form. The mold 1902 can then heat the solid metal via the heating elements 1908 to melt the metal, then once melted, the mold 1902 can stop providing heat via the heating elements 1908 and the liquid metal 1906 sets from reduced temperature, then the mold 1902 is removed.

The heat setting construction system 1900 may also incorporate a wood-based material for creating structural elements. In some implementations, wood powder or pieces are mixed with a heat-setting binder, such as a specialized glue. This wood-based mixture is poured into the mold 1902 and externally heated by the heating elements 1908 to set the material into a solid form. The mold 1902 may contain a heating element and the molds may heat the wood mixture within the molds to set the wood mixture. Once set, the molds may be removed. Similar to the liquid metal 1906 poured from the pouring direction 1904 as described above, the material that includes wood-based material is poured from the pouring direction 1904 into an enclosure defined by the mold 1902.

In some cases, the mold 1902 provides heat necessary for setting the construction materials, in contrast with a system that includes external heating elements. This configuration allows for more precise control of the heating process and potentially faster production of structural elements. The heating elements 1908 of the mold 1902 may be various heaters and may be an electric heater. The heating elements 1908 of the mold 1902 may be powered by a battery or on-site electricity source.

The mold 1902 may have various dimensions and have various lengths, widths, and thicknesses. The mold 1902 may be filled from various locations on the mold 1902, including the pouring direction 1904, as an example. The top of the mold 1902 may be removed and the mold 1902 may be filled from the top of the molds, e.g., as illustrated by the pouring direction 1904. When the mold 1902 is heated, the mold 1902 may be sealed and be fluid tight, such that fluid cannot be poured into the enclosure defined by the mold 1902 from the pouring direction 1904 when the heating elements 1908 are activated and heating the fluid within the mold 1902.

The mold 1902 may be manually assembled in portions. The mold 1902 may be assembled for the entire structure to be formed before filling the mold 1902, or sections of the structure to be formed may be constructed in phases with the mold 1902.

The heat setting construction system 1900 is adaptable to various types of construction materials. In some implementations, a mixture of wood, insulation, waterproofing materials, and a heat-setting binder may be combined and poured into the mold 1902 from the pouring direction 1904 to create a multi-functional structural material. When set with heat in mold 1902 by the heating elements 1908, this composite material forms elements that provide structural support, insulation, and waterproofing properties simultaneously.

The system 1900 may incorporate sectioned molds (e.g., sections of the enclosure mold 1902) to accommodate different materials within a single structural element. In some cases, individual fluids (such as metal, wood-based mixtures, waterproofing compounds, or insulation materials) may be poured into separate sections of the mold 1902. These sections may be heated and set individually or simultaneously, depending on the specific requirements of the construction project.

In some implementations, the heat setting process involves layered construction. Each material layer may be set individually, with subsequent layers bonded to the previous ones through the heating process or an adhesion process. Alternatively, all layers may be set together in a single heating cycle, potentially creating stronger bonds between the different materials.

The heat setting construction system 1900 may be designed to accommodate plumbing, electrical wiring, and conduits for air conditioning and heating systems. In some cases, these elements are positioned within the mold 1902 before the construction materials are poured and set (e.g., before the liquid metal 1906 is poured into the mold 1902 from the pouring direction 1904). This approach allows for the integration of various building systems directly into the structural elements during the construction process.

The materials used in the heat setting construction system may be selected for their ability to withstand the heat setting process without degradation. This consideration may be particularly important for integrated elements such as plumbing or electrical components.

In some implementations, the heat setting process is initiated by introducing a setting agent into the fluid materials. The mold 1902 may be designed to mix the setting agent with the construction fluids at a specific point in the process, where the mold 1902 may comprise a mixing device (not illustrated in FIG. 19). Alternatively, the system 1900 employs ultrasonic or ultraviolet methods to trigger the setting process, offering more precise control over the timing and progression of material solidification.

The heat setting construction system 1900 offers benefits in terms of construction speed and cost efficiency. By allowing for the rapid creation of complex structural elements with integrated functional properties, the system 1900 reduces on-site construction time and labor requirements.

In some cases, the heat setting construction system 1900 is adaptable to both on-site and off-site manufacturing processes. This flexibility allows for the creation of prefabricated structural elements in controlled factory environments, which can then be transported to construction sites for assembly.

The system 1900 is scalable to accommodate various sizes of structural elements, from small components to large-scale building sections. This scalability makes the heat setting construction system 1900 applicable to a wide range of construction projects, from residential buildings to commercial and industrial structures.

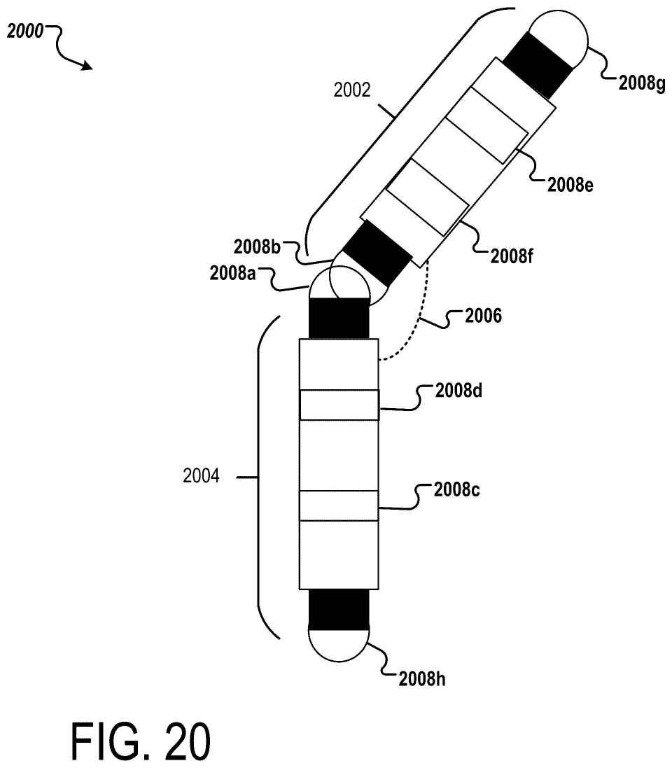

Referring to FIG. 20, an angled gear system 2000 is implemented to transmit rotational motion between non-parallel gears. The system 2000 includes two gears (a first gear 2002 and a second gear 2004) arranged at various angles relative to each other (e.g., angle 2006), allowing for power transmission across different angular positions.

In some cases, the gears have semi-circular gear teeth (e.g., semi-circular gear teeth 2008a-h) along the circumference of each respective gear. The semi-circular shape of the teeth 2008a-h enables the gears 2002, 2004 to mesh and transmit motion while positioned at various angles. This tooth geometry allows for greater flexibility in gear positioning compared to traditional straight or helical gear teeth. In some implementations, the semi-circular gear teeth 2008a-h are positioned along the outer edge of each gear 2002, 2004. This arrangement enables engagement between the gears 2002, 2004 despite their angled configuration (e.g., the angle 2006 between the first gear 2002 and the second gear 2004).

The angled gear system 2000 includes the first gear 2002, which extends upward at an angle while the second gear 2004 remains in a horizontal (or vertical) orientation. Each gear changes its angle relative to the other gear while both gears turn. Alternatively, one of the gears changes its angle relative to the other gear while both gears turn.

The semi-circular gear teeth 2008a-h may be designed to maintain proper meshing and power transmission across different angular positions. In some cases, the curved geometry of the gear teeth 2008a-h allows for smoother engagement and disengagement as the gears rotate, potentially reducing wear and noise.

The angled gear system 2000 is adaptable to various shaft angles. In some implementations, the same gear design is used for multiple angle configurations, providing flexibility in mechanical system design. The ability to transmit power between non-parallel shafts allows for more compact or efficient machine layouts in certain applications. The gears 2008a-h are configured such that mechanical power can transmit between adjacent gears.

In some cases, the angled gear system 2000 incorporates materials selected for durability and low friction. The gears may be made of metal, plastic, or other materials. The gear teeth 2008a-h may be manufactured with high precision to ensure proper meshing and minimize backlash between the angled gears. Lubrication systems may be integrated to reduce wear and maintain smooth operation of the angled gear assembly.

The angled gear system 2000 is scalable to different sizes and power transmission requirements. Smaller versions may be suitable for precision instruments or small mechanical devices, while larger implementations are relevant for industrial machinery or automotive applications. The angled gear system 2000 may be used for various types of gears, including spur gears, bevel gears, or other gear configurations. The angled gears may have various dimensions, widths, lengths and heights.

In some implementations, the angled gear system 2000 includes additional features such as adjustable mounting systems to fine-tune the gear angles or tensioning mechanisms to maintain proper gear engagement over time. These features enhance the versatility and longevity of the angled gear system in various mechanical applications.

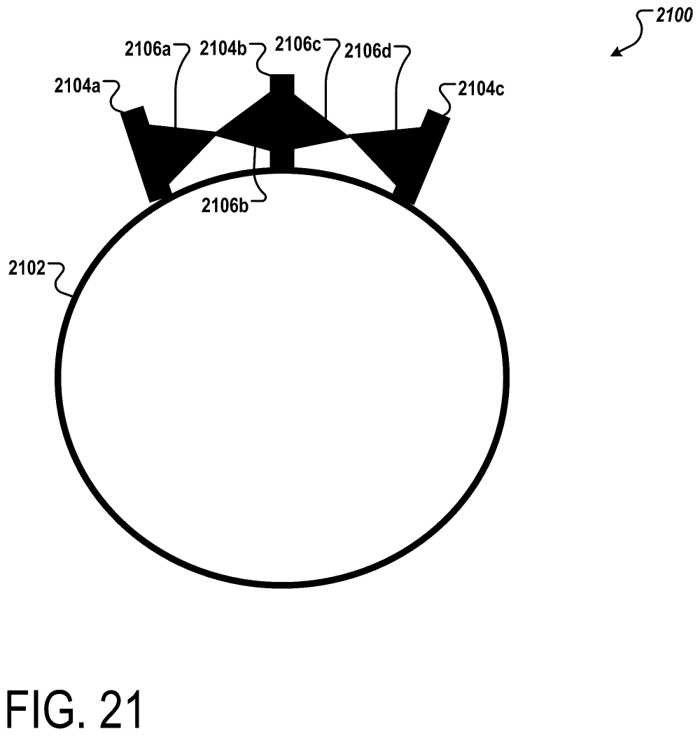

Referring to FIG. 21, a circular gear teeth system 2100 is implemented to allow for gear engagement across a wide range of angles. The system includes a gear 2102 with uniquely shaped gear teeth (e.g., gear teeth 2104a-c) designed to maintain proper meshing in various orientations.

In some cases, the gear teeth 2104a-c have a circular shape along their outer edge. FIG. 21 illustrates a cross-sectional view of the gear 2102 with circular teeth 2104a-c. As shown in FIG. 21, the circular gear teeth 2104a-c are arranged around the circumference of the gear 2102. The gear 2102 illustrated in FIG. 21 includes three gear teeth (e.g., 2104a-d). Additional gear teeth can be positioned along the entire circumference of the gear 2102.

The circular gear teeth 2104a-c are connected by cone-shaped elements 2106a-d between adjacent teeth. For example, the cone-shaped elements 2106a-b connect the gear teeth 2104a-b. In some implementations, a base of each cone-shaped element 2106a-d connects to one circular tooth, while a point of the respective cone-shaped element 2106a-d connects to a point of an adjacent cone-shaped element 2106a-d connected to an adjacent circular gear tooth. This configuration creates a continuous surface along the gear's circumference. For example, a base of the cone-shaped element 2106a is attached to the gear tooth 2104a and a point of the cone-shaped element 2106a is connected to a point of the cone-shaped element 2106b, whose base is connected to the gear tooth 2104b.

The cone-shaped elements 2106a-d between the circular teeth 2104a-c curves inward along their length. This curvature allows for smoother transitions between teeth during gear rotation and engagement. The curved property of the cone-shaped elements 2106a-d also contributes to maintaining proper tooth contact across different gear angles where a circular gear tooth of the adjacent gear connects between two adjacent circular gear teeth of the first gear over and connecting to the two cones between the two adjacent circular gear teeth of the first gear. The curvature of the circular gear teeth and the curvature of the two cones may be aligned and the same angle of curvature for the two cones across the length of the outer face of the two cones for connecting circular gear teeth and two cones.

In some cases, the circular gear teeth 2104fa-c and curved cone-shaped elements 2106a-d enable gear engagement at various angles approaching 360 degrees. This flexibility in engagement angles allows for more diverse gear configurations compared to traditional gear designs with straight or angled teeth. Two gears each with circular gear teach and two cones between two adjacent circular gear teeth around the circumference of each gear may engage and turn together to transmit power, where the angle of one or both gears may change relative to the other gear while both gears turn, where the angle of change may be up to approximately 360 degrees.

The circular gear teeth 2104a-c may remain uniform around the circumference of the gear 2102. This uniformity helps ensure consistent performance regardless of the rotational position of the gear 2102 (e.g., around an axis of the gear). The consistent tooth shape also contributes to smoother operation and potentially reduced wear over time.

The cone-shaped elements 2106a-d between the circular teeth 2104a-c enable the gear 2102 to maintain engagement with a mating gear across different angles while the gears are turning. This capability allows for dynamic adjustment of gear positioning during operation, enabling more compact or flexible mechanical designs.

In some implementations, the circular gear teeth system 2100 are manufactured using high-precision techniques to ensure proper tooth geometry and spacing. The specific dimensions and curvatures of the circular teeth 2104a-c and cone-shaped elements 2106a-d may be optimized based on the intended application and expected range of engagement angles.

The circular gear teeth 2104a-c design are applicable to various types of gears, including spur gears, bevel gears, or other gear configurations. The system 2100 is scalable to different gear sizes, from small precision components to larger industrial applications. A gear with circular gear teeth may have various dimensions, lengths, widths, and heights.

In some cases, the circular gear teeth 2104a-c are constructed from materials selected for durability and low friction. Components of the system 2100 may be made of metal, plastic, or other materials. Lubrication systems may be integrated to reduce wear and maintain smooth operation across the range of possible engagement angles.

The circular gear teeth system 2100 provide advantages in terms of design flexibility and adaptability in mechanical systems. By allowing for gear engagement across a wide range of angles, the system 2100 enables more compact machinery layouts or facilitate the development of mechanisms with variable gear orientations.

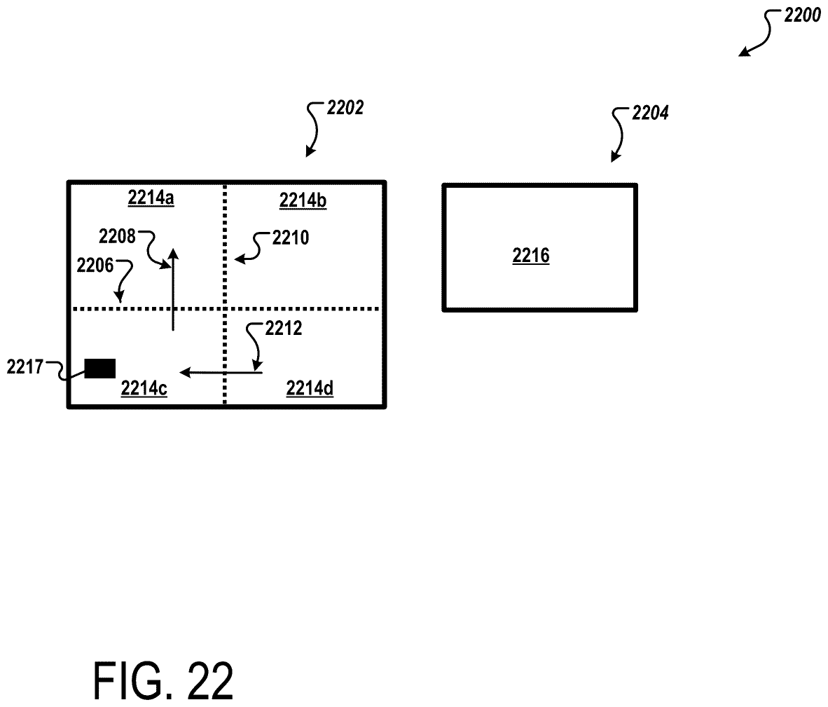

Referring to FIG. 22, a foldable laptop and tablet system 2200 is implemented to provide a compact, versatile, and foldable computing device. The system 2200 incorporates multiple folding sections 2214a-d across a length and/or width of a device that allow the device to be reduced in size for portability (e.g., by folding the device along fold lines between the sections 2214a-d) while maintaining full functionality when unfolded. The device can be configured in an unfolded configuration 2202 and a folded configuration 2204. In some implementations, the device operates as a laptop or tablet when configured in the unfolded configuration 2202. In some implementations, the device operates as a mobile device when configured in the folded configuration 2204.

In some cases, the foldable device includes four or more sections that can be folded along fold lines both horizontally and vertically. For example, the unfolded configuration 2202 illustrates a horizontal fold line 2206, in which the device can fold along the horizontal fold line 2206 in a first fold direction 2208. The unfolded configuration 2202 illustrates a vertical fold line 2210, in which the device can fold along the vertical fold line 2210 in a second fold direction 2212. This multi-directional folding capability along multiple non-colinear fold lines allows the device to be compacted to a size small enough to fit in a user's pocket when fully folded (e.g., the size of a hand-held device). When the device is configured in the unfolded configuration 2202, the folding sections may be aligned on the same plane and when the device is configured in the folded configuration 2204, the folded sections may be overlapping and touching. For example, the face and/or back of each section is aligned and in contact with a face and/or back of another section of the device.

The fully folded configuration can be approximately the size of a hand-held device. Typical hand-held devices have dimensions of less than 10 inches of height, less than 4 inches in width, and less than 1 inch in thickness. In some cases, the dimensions are designed for ergonomic use, to be used primarily with one hand, whiles having enough screen surface area for a usable interface.

In the unfolded configuration, the device is approximately a laptop size. Typical laptops have a diagonal screen width greater than 10 inches, with common widths ranging from 11 inches to 15 inches. Typical laptops have a thickness between 0.5 inch and 1.5 inches. The laptop dimensions provide a balance between portability and functionality, often include foldable keyboards, and at least one battery.

As an example process of converting the device from the unfolded configuration 2202 to the folded configuration 2204, the device is folded along the horizontal fold line 2206 in the first fold direction 2208. As such, the device is configured in an intermediate configuration in which the face of section 2214c is in contact with the face of section 2214a and the face of section 2214d is in contact with the face of section 2214b. The device is then folded along the vertical fold line 2210 in the second fold direction 2212. As such, the device is configured in the folded configuration 2204 such that the back of section 2214d is in contact with the back of section 2214c (or the back of 2214b is in contact with the back of 2214a if the fold occurs in an opposite direction). In the folded configuration 2204, the top of the folded device is the back of section 2214b and represents a screen 2216 of the folded device (e.g., top of a smartphone).

The computing components of the device may be distributed across the various folding sections. Computing components such as a processor and memory may be in the same or different fold sections of the device. In some implementations, these components are connected through the fold lines, allowing for continuous operation in both folded and unfolded states. The connection between fold sections of the device may include an electrical connection.

The foldable laptop device includes traditional components of a laptop such as a display, keyboard, and trackpad, among other features. For example, the sections 2214c-d include the keyboard and trackpad and the sections 2214a-b include the display. The foldable tablet device configured in the unfolded configuration 2202 may include traditional components of a tablet including a touchscreen and other features.

The top external fold of the device (e.g., the back of the section 2214b, which is the screen 2216 in the folded configuration 2204) may incorporate a smartphone functionality (e.g., an outermost surface of the device in the folded configuration 2204). The folded configuration 2204 may allow users to access smartphone features without needing to unfold the entire device. In some cases, the smartphone portion utilizes the computing components used for the laptop or tablet functions in the unfolded configuration 2202, reducing redundancy in hardware.

Each of the fold lines 2206, 2210 in the device may include a hinge mechanism. There are one or more hinges for each fold, and the hinge connects adjacent fold sections of the device. These hinges are designed to provide smooth folding action while maintaining structural integrity in both folded and unfolded positions. In some implementations, the hinges incorporate locking mechanisms to secure the device in various folded configurations. The locking mechanism is configured to secure the device in a fully folded configuration, a partially unfolded configuration, and a fully unfolded configuration. Other folding connection mechanisms may be used. In some cases, a signal generated by a sensor 2217 can determine if the device is in the folded configuration 2204 or unfolded configuration 2204 (or the intermediate configuration(s)) and engage the locking mechanisms appropriately. In some implementations, the sensor 2217 is positioned within the hinges and/or within the sections of the device (as illustrated in FIG. 22). In some cases, the locking mechanism includes a pressure-sensitive device to initiate an unlocking of the locking mechanism upon detecting a folding and/or unfolding of the device.

In some cases, the hinge mechanisms provide electrical connection between the folds of the device and between each section of the device. Each hinge can include multiple electrical connections and various types of electrical connections. Alternatively, or additionally, flexible wires may electrically connect each section through the hinges of each section, in which the wires can be positioned within each hinge. In some cases, a hinge includes one or multiple flexible wires.

If more than one hinge is used for a particular fold, only one hinge may have electrical connection between associated sections. Alternatively, multiple or all of the hinges of a fold line may have electrical connections, and this could be with electrically enabled hinges, flexible wires, or both.

The computing components within the device can be configured in a variety of configurations. In particular, the device can include different computing components and different configurations of computing components within sections. For example, a foldable laptop configured in the unfolded configuration 2202 can include display sections that may not include computing components, other than potentially the smartphone display section when the device includes a smartphone display, which can be touch sensitive. As another example, foldable tablets can include computing components that may be included in touch sensitive display sections. The foldable tablet configured in the unfolded configuration 2202 can include a display for a smartphone, which includes a touch sensitive display as well. A section of the tablet display can be used for the smartphone display, alternatively and additionally, a display can be included for the smartphone display. For the foldable laptop configuration in the unfolded configuration 2202, a keyboard and trackpad can be included for the device, in which each may be foldable between two or more sections.

The foldable laptop and tablet system 2200 is designed to transition between multiple states. When fully unfolded in the unfolded configuration 2202, the device may function as a traditional laptop or tablet computer with a large display area and full keyboard for the laptop. In some implementations, if the device is configured in the folded configuration 2204, the device is compacted to a smaller form factor while still allowing access to smartphone functionality through the top outer face portion of the device (e.g., the back of the section 2214b, and represented by the screen 2216). In these implementations, the smartphone portion of the outer face of the top fold of the device may include a touch screen display. In some implementations, the device does not have smartphone functionality on the top fold of the device.

In some cases, the display technology used in the foldable device is designed to accommodate the stress of repeated folding and unfolding. This may involve the use of flexible display materials or segmented display panels that align when the device is unfolded. The flexible display of the device may span multiple fold sections of the device. For example, the display portion can extend from the section 2214a to the section 2214b across the vertical fold line 2210.

The foldable design may allow for various intermediate configurations between the unfolded configuration 2202 and the folded configuration 2204. These intermediate configurations provide different form factors suitable for various use cases, such as a partially unfolded configuration for use as a smaller tablet or a tented position for media viewing. For example, the device can include a touch screen display on the back of the sections 2214c and sections 2214d. In this case, the device can operate as a tablet if the device is folded along the horizontal fold line 2206 in the first fold direction 2208.

The system 2200 incorporates the sensor(s) 2216 to generate a signal processed by a computer included in the system 2200 to detect a current folding configuration of the device. In some implementations, the sensor(s) 2217 communicate with the device's operating system to automatically adjust a user interface and functionality based on the current configuration. The device may automatically adjust the user interface transitioning between a smartphone interface and a tablet interface or a laptop interface based on the detected folding configuration. In some implementations, the sensor 2217 is a pressure sensor that generates an electrical signal in response to two sections of the device becoming in contact (e.g., upon contact between the face of the section 2214c and the face of the section 2214a). The pressure sensor can be positioned on an exterior of one or more sections of the device. In addition, the hinge(s) of the device can include sensors to determine a position of the hinge(s), in which different hinge positions generate a different pressure sensor signal. Other sensors are possible for detecting the current folding state of the device including vision sensors.

The foldable laptop and tablet system may include a power management system designed to efficiently distribute power across the various sections of the device. This may involve the use of battery technologies or multiple battery cells positioned throughout the folding sections. The battery may be flexible. Distributing power may include a process for selectively activating and deactivating components in different folding sections based on whether those sections are currently in use in the device's configuration. For example, if section 2214a includes a display when the device is configured in the unfolded configuration 2202, the display of the section 2214a can be inactive when the device is in the folded configuration 2204, because the only required display in the folded configuration 2204 is the screen 2216. In some implementations, the device incorporates advanced cooling systems distributed across the folding sections to ensure proper thermal regulation in both configurations 2202, 2204.

Various configurations of the battery or batteries of the device can be used for the foldable computing device. For example, each section of the device can include a battery. Alternatively, only a subset of the sections of the device can include a battery. The power management system can send electricity from any battery of the device to the computing components via electrical connections (e.g., via electrically-enabled hinges) and can adjust an amount of electricity to be sent to various components of the device.

In some cases, the device incorporates a stylus or other input device that can be stored within one of the folding sections. This integration provides additional input options while maintaining the compact nature of the folded device.

By combining the functionality of a laptop, tablet, and smartphone in a foldable form factor, this system provides users with a versatile computing device that adapts to various usage scenarios while maintaining portability. The multi-fold design allows for significant size reduction when not in use, increasing the convenience of carrying a full-featured computing device.

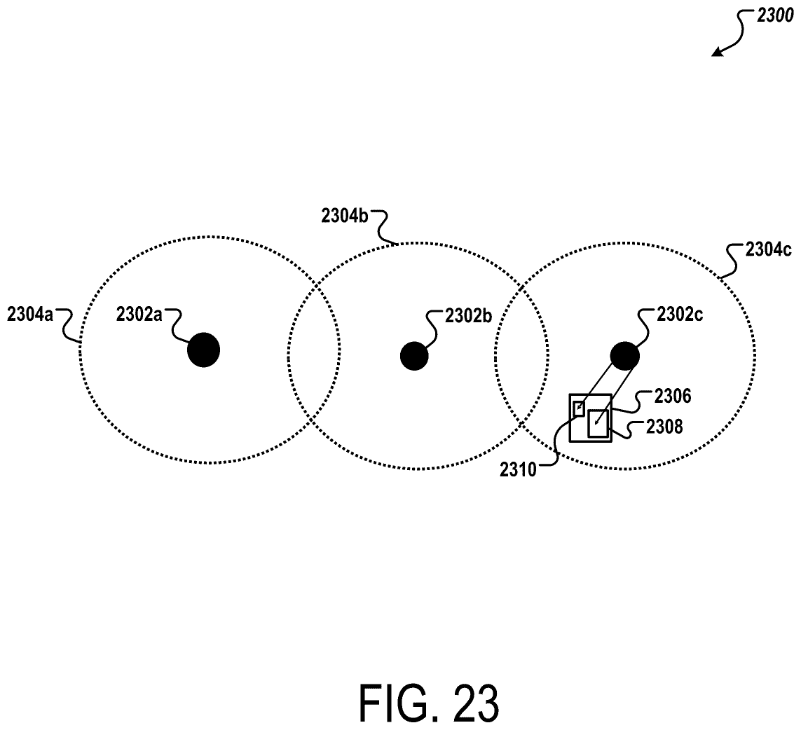

Referring to FIG. 23, a wireless electricity network system 2300 is implemented to provide power to electronic devices without a need for physical connections between the electronic devices and a power source. The system 2300 allows the devices to connect to a wireless electricity network in a manner similar to how devices connect to Wi-Fi networks for data transmission.

In some cases, the wireless electricity network includes multiple local wireless electricity transmitters distributed across an area. For example, the system 2300 illustrated in FIG. 23 includes local wireless electricity transmitters 2302a-c. These transmitters 2302a-c may be positioned to create overlapping transmission areas, allowing for continuous power delivery as devices move between coverage zones. For example, a transmission area 2304a associated with the transmitter 2302a overlaps with a transmission area 2304b and a transmission area 2304c that also overlaps with transmission area 2306b.

The system 2300 incorporates the local wireless electricity transmitters 2302a-c that can detect and authenticate devices within their respective transmission area. In some implementations, a device is configured to connect to available wireless electricity networks, potentially paying a fee or requiring a subscription for access. Authentication of the devices by the transmitters 2302a-c may be automatic and controlled by a computer and software.

An electronic device 2306 compatible with the wireless electricity network that includes the transmitters 2302a-c includes a battery 2308 and a wireless electricity receiver 2310 or may not include the battery 2308. The local wireless electricity transmitters 2302a-c may provide power to charge the device's battery 2308 and/or directly power the device's operations through wireless transmission. As illustrated in FIG. 23, the transmitter 2302c transmits wireless electrical energy and is received by the wireless electricity receiver 2310 of the electronic device 2306.

In some cases, the wireless electricity network system 2300 utilizes one or more types of wireless power transfer technologies. These may include Radio Frequency (RF) Wireless Power Transfer, Inductive Wireless Power Transfer, Inductive Resonant Wireless Power Transfer, Capacitive Wireless Power Transfer, Ultrasound (Electro-Mechanical) Wireless Power Transfer, Laser Wireless Power Transfer, or Electric Vehicle (EV) Wireless Power Transfer.

The wireless electricity network system 2300 may be designed to allow electronic devices to automatically connect to other wireless electricity transmitters by the same carrier when moving between locations. This feature provides seamless power delivery across extended areas covered by multiple transmitters. For example, if the computing device 2306 moves towards the transmitter 2302b, the device 2306 can automatically receive wireless electrical energy from the transmitter 2302b rather than (or in addition to) the transmitter 2302c.

In some implementations, the wireless electricity transmitters 2302a-c have overlapping coverage at the edges of their transmission areas 2304a-c. This overlap ensures continuous power delivery as devices transition between adjacent transmitter coverage zones.

The system 2300 may include mechanisms for devices to detect available wireless electricity networks and/or nearby transmitters and to initiate connection processes to receive wireless electrical energy from a nearby transmitter. In some cases, these mechanisms involve authentication protocols to verify device eligibility for accessing the network of transmitters. The authentication of devices may be done by the wireless electricity network system 2300. The device may include settings set by the user to use the wireless electricity network. The settings may include when to connect to the wireless electricity network, such as an amount that the battery of the device is depleted. The wireless electricity network system 2300 may be controlled by a computer(s) and software.

The wireless electricity network system 2300 is adaptable to various environments and applications. In some cases, the wireless electricity network system 2300 may be implemented in homes, offices, public spaces, or transportation systems to provide widespread access to wireless power. The wireless electricity network system 2300 may include many (e.g., 100s or 1,000s) of transmitters and can be implemented throughout a city. Electronic devices (e.g., the electronic device 2306) that receive electrical power from the wireless electricity network may include smartphones, cellphones, tablets, laptops, other portable computing devices, other portable electronic devices, electric vehicles, and other electronic devices.

The system 2300 may incorporate safety features to manage power transmission levels and prevent overcharging of connected devices. In some implementations, the network adjusts power output based on the number and types of devices connected to each transmitter. Each wireless electricity network system 2300 may supply electricity to one or multiple connected devices within each local transmitter's transmission area.

By providing a wireless method for delivering electrical power to devices, the wireless electricity network system 2300 offers increased flexibility and convenience compared to traditional wired power delivery methods. The system's ability to provide power across extended areas through multiple interconnected transmitters enables new applications and usage scenarios for portable electronic devices.

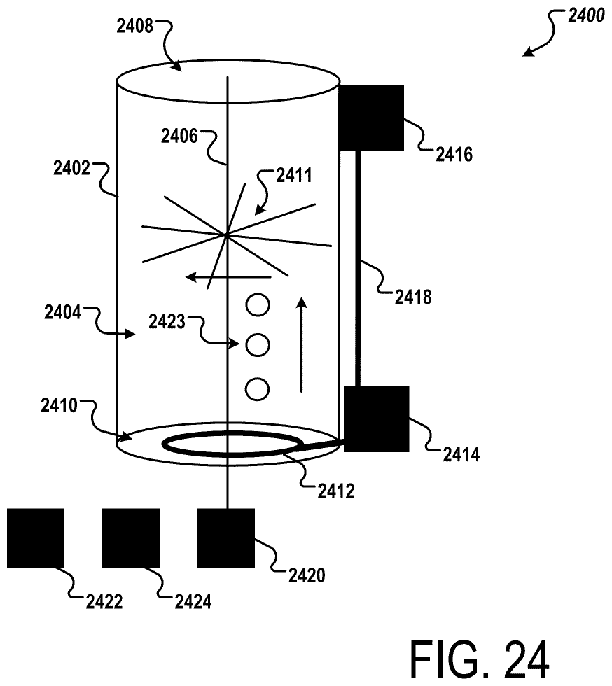

Referring to FIG. 24, a gas cylinder system 2400 is implemented to generate electricity using rising gas to drive a turbine(s). The system 2400 includes an airtight cylinder 2402 containing a fluid 2404, such as water, and a gas that is lighter than the fluid.

In some cases, the cylinder 2402 may be tall, with a height ranging, e.g., from 0.05 to 5,000 feet. The diameter of the cylinder 2402 varies, e.g., from 0.05 to 2,000 feet, depending on the specific implementation and power generation requirements.

The system 2400 incorporates a central rod 2406 extending vertically through the cylinder 2402 from a top location 2408 to a bottom location 2410. One or multiple turbine fans 2411 are mounted on the rod 2406 and spaced apart along the length of the rod 2406. In some implementations, the turbine fans 2411 span the approximate width of the cylinder 2402 to maximize interaction with the rising gas within the cylinder 2402.

At the bottom location 2410 of the cylinder 2402, a gas introduction mechanism is positioned to release gas into the fluid contained in the cylinder 2402. This mechanism includes a circular hose 2412 with holes spaced along the length of the hose 2412, as illustrated, or may include multiple hoses arranged across the bottom location 2410 of the cylinder 2402. Other gas introduction mechanisms may be used. The gas introduction mechanism is connected to an external fan or pump 2414 to supply gas into the cylinder 2402.

As added gas from the gas introduction mechanism is released into the fluid contained in the cylinder 2402, the added gas rises through the cylinder 2402 from the bottom location 2410 towards the top location 2408 due to a lower density of the added gas in comparison with the fluid contained in the cylinder 2402. The upward movement of gas bubbles 2423 through the fluid contained in the cylinder 2402 and the resulting fluid displacement cause the turbine fans 2411 to spin as the gas passes across the blades of the turbine fans 2411. This spinning motion of the turbine fans 2411 causes a rotation of the central rod 2406.

The system 2400 includes 1 to, e.g., 100,000 turbine fans within the cylinder 2402. The turbine fan blades may be angled and/or curved to optimize interaction with the rising gas and fluid movement. Each turbine fan has 2 to, e.g., 5,000 fan blades, depending on the specific design requirements.

The system 2400 incorporates a gas collection device 2416 positioned near the top location 2408 of the cylinder 2402. The gas collection device 2416 is connected to a hose 2418 that runs along an exterior portion of the cylinder 2402 from a position near the top location 2408 to a position near the bottom location 2410. The pump 2414 is configured to recirculate the collected gas back to the bottom location 2410 of the cylinder 2402 via the gas introduction mechanism, creating a continuous cycle of gas flow from the bottom location 2410 towards the top location 2408 of the cylinder 2402.

In some implementations, the central rod 2406 is connected to a generator 2420 positioned outside the cylinder 2402. As the rod 2406 rotates due to the spinning turbine fans 2411, the rotation of rod 2406 drives the generator 2420 to produce electricity.

The system 2400 includes a computer 2422 for control and monitoring purposes. This computer 2422 manages various aspects of the system's operation, such as gas flow rates, turbine speeds, and power output. A battery 2424 is included to provide power for system startup and may support the computer 2422 and other electrical components of the system 2400 (e.g., the pump 2414). The electrical components of the system may be powered by the generator 2420 after the startup period.

In some cases, multiple rods with turbine fans are incorporated within a single cylinder. These rods may be arranged in various configurations, such as a circular pattern or a grid layout. Each rod may be connected to its own generator, increasing the overall power output of the system.

The added gas used in the system may be helium, hydrogen, air, or other gases that are lighter than the fluid in the cylinder. The choice of gas depends on factors such as availability, cost, and safety considerations. The fluid contained in the cylinder 2402 may be water or other fluids.

By utilizing the natural buoyancy of gases in a fluid medium, the system 2400 provides a method for generating electricity without relying on combustion or other chemical processes. The continuous cycle of gas rising from the bottom location 2410 to the top location 2408 and recirculation via the gas collection device 2416 and the hose 2418 allows for ongoing power generation as long as the system is maintained and operated.

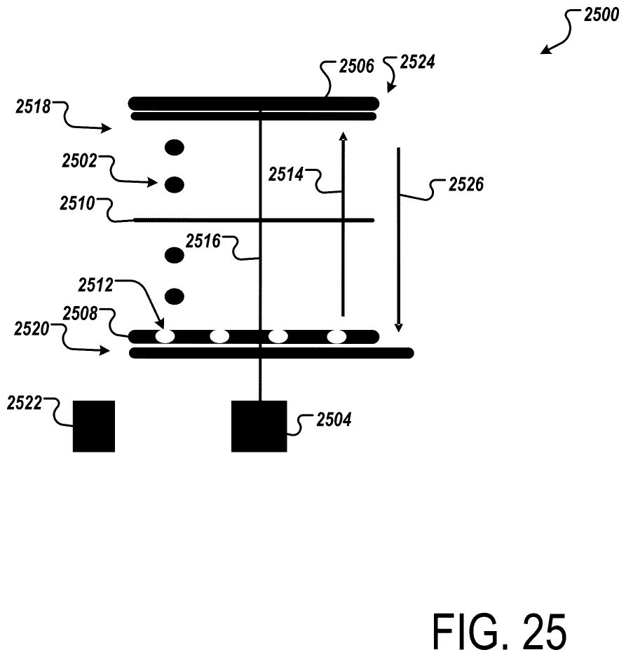

Referring to FIG. 25, a metal particle movement magnet system 2500 is implemented for generating electricity. The system 2500 utilizes magnetic attraction to move metal particles 2502 and drive a generator 2504.

The system 2500 includes a magnet 2506 positioned above a metal particle releasing system 2508. One or multiple turbine fans 2510 or blades may be positioned between the magnet 2506 and the metal particle releasing system 2508. The turbine fan(s) 2510 or blade(s) may be angled or angled and curved. There may be various distances between the magnet 2506 and metal particle releasing system 2508 depending on the magnetic strength of the magnet 2506, where the metal particles 2502 may be attracted to the magnet 2506 throughout the entire distance between the metal particle releasing system 2508 and the magnet 2506.

The system 2500 incorporates the metal particle releasing system 2508 containing holes 2512 through which the metal particles 2502 are released. The metal particle releasing system 2508 is located at the ground of the system 2500. As the metal particles 2502 are released, they are attracted upwards toward the magnet above 2506.

The upward movement along an upward direction 2514 of the metal particles 2502 causes the turbine fan 2510 or blades to spin as the meal particles 2502 pass through the turbine fan 2510. The moving metal particles 2502 create wind in the upward direction 2514 and both the moving metal particles 2502 and wind created spin the turbine fan(s) 2510 or blade(s). A rod 2516 extends through the center of the system from a top location 2518 to a bottom location 2520, connecting to components of the turbine 2510 at a center position of the turbine 2510.

In some implementations, the system 2500 includes a metal particles reinsertion system near the bottom location 2520. This allows for continuous operation by recycling the metal particles 2502.

Components of the system 2500 are controlled by a computer 2522 to control various operational parameters of the system 2500. The generator 2504 is located at the base of the system near the bottom location 2520 or other location to convert mechanical energy of the spinning turbine 2510 into electrical energy.

The system 2500 includes the metal particle collection system that may utilize magnetic or mechanical methods to efficiently collect particles after they pass through the turbine 2510 before reaching the magnet 2506 or to remove the metal particles 2502 from the magnet 2506. The metal particle collection system moves the metal particles 2502 to a side location 2524 of the magnet 2506 and then lets the metal particles 2502 drop to the ground along a downward direction 2526 to be reinserted into the metal particle releasing system 2508 by the reinsertion system. The reinsertion system may be designed to return particles to the releasing system with minimal energy expenditure.

The metal particles 2502 follow the upward direction 2514 toward the magnet 2506 and the downward direction 2526 after reaching the magnet 2506 and after collection. The system 2500 may operate in a continuous cycle, with particles being released through the holes 2512, rising through the turbine 2510 along the upward direction 2514, being collected by the magnet 2506, and then reinserted for continued operation.

In some cases, the magnet 2506 positioned near the top location 2518 is an electromagnet. The strength of the electromagnet may be adjustable by receiving a particular setting from the computer 2522 to determine an amount of current to flow through the electromagnet to control the speed and force of the rising metal particles 2502. Alternatively, the magnet 2506 is a permanent magnet. Various electromagnets and permanent magnets may be used for the system 2500. When the magnet 2506 is an electromagnet, it may turn off during the metal particle collection process so that the metal particles 2502 are collected (e.g., return to the bottom location 2520 along the downward direction 2526).

The metal particle releasing system 2508 may be designed to release particles at controlled intervals or in specific patterns, as controlled by the computer 2522. This allows for optimization of particle flow and turbine rotation.

The turbine fan 2510 or blade arrangement may be configured with various blade designs to maximize energy capture from the rising particles 2502. In some implementations, multiple turbine stages are incorporated to increase overall energy generation.

The metal particles 2502 used in the system 2500 may be selected based on their magnetic properties and durability. Particles may be of various sizes or shapes to influence their movement and interaction with the turbine components. The metal particles 2502 may be a fine powder or in granular form. The metal particles 2502 may be made from magnets.

In some cases, the system 2500 incorporates multiple parallel particle streams and turbines within a single unit. This configuration increases the total power output of the system 2500.

The computer 2522 controlling the components of the system 2500 may adjust operational parameters based on factors such as desired power output, particle flow rate, and system efficiency. In some implementations, the computer 2522 incorporates algorithms to optimize system performance over time.

The generator 2504 connected to the turbine 2510 via the rod 2516 may be selected based on the expected rotational speed and torque produced by the particle-driven system. In some cases, the generator 2504 includes power conditioning equipment to produce electricity suitable for specific applications or grid integration. The generator 2504 may power the electric components of the system 2500 (e.g., the computer 2522). The system 2500 may include a battery which may power the electrical components of the system 2500 during a start-up period of the system 2500. The generator 2504 may produce electricity which may be used for various purposes such supplying electricity to utility grid.

By utilizing magnetic attraction to drive particle movement and turbine rotation, this system 2500 provides a method for generating electricity without relying on traditional fuel sources.

Other implementations are within the scope of the following claims.

What is claimed is

1. A foldable computing device, comprising:
a display portion comprising multiple folding sections, wherein the display portion is configured to fold horizontally and vertically;
a computing component positioned within a folding section; and
a plurality of hinge mechanisms each connecting two folding sections of the multiple folding sections,
wherein the display portion is foldable to a hand-held size in a fully folded configuration and a laptop size in an unfolded configuration, wherein the hand-held size is smaller than the laptop size.

2. The foldable computing device of claim 1, wherein the display portion comprises a flexible display that spans across a plurality of the multiple folding sections.

3. The foldable computing device of claim 1, wherein the computing component comprises a processor and memory.

4. The foldable computing device of claim 1, further comprising a smartphone portion integrated into an outer surface of the display portion when the display portion is configured in the fully folded configuration.

5. The foldable computing device of claim 4, wherein the smartphone portion is accessible when the device is in the fully folded configuration.

6. The foldable computing device of claim 1, wherein at least one hinge mechanism of the plurality of hinge mechanisms comprises a locking mechanism to secure the device in a folded configuration.

7. The foldable computing device of claim 6, wherein the locking mechanism is configured to secure the device in one of the fully folded configuration, a partially unfolded configuration, and a fully unfolded configuration.

8. A method of operating a foldable computing device, comprising:
unfolding multiple folding sections of the foldable computing device to transform the foldable computing device from a fully folded configuration to an unfolded configuration, each folding section vertically or horizontally hingedly coupled to another folding section; and
activating a computing component positioned within at least one folding section of the multiple folding sections,
wherein the foldable computing device has a hand-held size when in the fully folded configuration and a laptop size when in an unfolded configuration.

9. The method of claim 8, further comprising:
activating a smartphone portion integrated into an outer surface of the foldable computing device when the device is in the fully folded configuration.

10. The method of claim 9, wherein the smartphone portion remains accessible and functional when the device is in the fully folded configuration.

11. The method of claim 8, further comprising:
detecting a current folding configuration of the foldable computing device using one or more sensors; and
automatically adjusting a user interface of the foldable computing device based on the detected current folding state.

12. The method of claim 11, wherein automatically adjusting the user interface comprises transitioning between a smartphone interface, a tablet interface, and a laptop interface based on the detected current folding configuration.

13. The method of claim 8, further comprising:
distributing power from a battery across the multiple folding sections.

14. The method of claim 13, wherein distributing power comprises selectively activating or deactivating components in different folding sections based on whether those sections are in use.

15. A foldable computing system, comprising:
a foldable display having at least four folding sections, each folding section configured to fold horizontally or vertically relative to another folding section;
a processor positioned within at least one of the folding sections;
a memory positioned within at least one of the folding sections; and
a top external folding section incorporating smartphone functionality, wherein the system is operable in a fully folded configuration and an unfolded configuration, wherein the top folding section is positioned on a top surface of the system in the fully folded configuration.

16. The foldable computing system of claim 15, further comprising a battery positioned within at least one of the folding sections.

17. The foldable computing system of claim 16, wherein the battery is configured to power the processor of the foldable computing system.

18. The foldable computing system of claim 15, further comprising one or more sensors configured to detect a folding configuration of the system.

19. The foldable computing system of claim 15, further comprising enabling a smartphone interface to be activated when the system is in the folded configuration.

20. The foldable computing system of claim 18, wherein the system comprises a smartphone interface when in the fully folded configuration and a laptop or tablet interface when in the unfolded configuration.
